(19) United States
(12) Patent Application Publication
(10) Pub. No.: US 2025/0224970 A1
(43) Pub. Date: Jul. 10, 2025

(54) SYSTEMS AND METHODS FOR OPTIMIZING SYSTEM RESOURCES VIA ARTIFICIAL INTELLIGENCE FOR DISPLAYING ANALYTICS USING AN INTERACTIVE USER INTERFACE

(71) Applicant: MASTERCARD INTERNATIONAL INCORPORATED, Purchase, NY (US)

(72) Inventors: Manash Bhattacharjee, Jersey City, NJ (US); Edward Grunde McLaughlin, Newtown, PA (US)

(21) Appl. No.: 19/093,914

(22) Filed: Mar. 28, 2025

Related U.S. Application Data
(63) Continuation-in-part of application No. 15/833,681, filed on Dec. 6, 2017, now abandoned.

(51) Int. Cl. G06F 9/451; G06F 11/34; H04L 67/306

(52) U.S. Cl. CPC G06F 9/451; G06F 11/3438; H04L 67/306

(57) ABSTRACT

Systems and methods for an analytics computing device including: (a) causing presentation of a graphical user interface (GUI) on a display of a user's computing device; (b) receiving selection data corresponding to a plurality of selections made by the user via the GUI including metrics request data associated with a plurality of merchant metrics and sector request data associated with a plurality of sectors; (c) analyzing the selection data to determine the requested merchant metrics that exceed a threshold and the requested sectors that exceed a threshold; (d) storing a user profile in a first portion of a memory including first and second data representing the requested merchant metrics and the requested sectors satisfying the thresholds; and/or (e) for a subsequent interaction with the GUI by the user, causing a graphical representation to be displayed via the GUI at the start of the subsequent interaction based on the user profile.

### CROSS REFERENCE TO RELATED APPLICATION

This application is a continuation-in-part of and claims the benefit of priority to U.S. patent application Ser. No. 15/833,681 filed on Dec. 6, 2017, the entire contents and disclosures of which are hereby incorporated herein by reference in its entirety.

### BACKGROUND

The field of the disclosure relates generally to causing data analytics to be displayed on an interactive user interface, and, more specifically, to network-based methods and systems for optimizing system resources using artificial intelligence (AI) for displaying data analytics on an interactive user interface.

The need to display data analytics on an interactive user interface is ever increasing in today's computer environment. More and more data analytics are being generated by computer systems. The amount of computer resources needed to generate these data analytics is ever increasing. Moreover, the amount of computer resources needed to quickly display this data on an interactive user interface and then quickly display other data in response to a user input into the interactive user interface is also ever increasing. Known computer systems struggle to quickly display (real-time display) large amounts of a first data set on an interactive user interface, and then quickly display large amounts of a second data set on the same interactive user interface in response to an input from a user using the interactive display even when the first data set and the second data set at least partially overlap. More efficient ways of displaying and changing the display are needed.

For example, there are many parties interested in the value of a merchant, including, but not limited to, commercial real estate owners, lenders, and brokers, as well as business owners, managers, and marketing directors. However, it is difficult to assess the value of a merchant in a manner that facilitates comparison of the merchant to other merchants in varying locations (e.g., in different areas of a city, in different states, in different countries). In particular, it may be difficult to discern which merchants demonstrate improvised key business characteristics-such as growth rate, revenue stability, or consumer traffic-relative to other merchants. In some cases, it is only assumed that certain merchants are “top” earners or “top” locations. In situations where financial decisions (e.g., the distribution of marketing funds) are being made based on a relative ranking of merchants, having a more reliable metric to compare and contrast the success of one merchant compared to all other merchants may be beneficial.

Moreover, parties that offer loans to merchants (e.g., loan issuing entities) may be unable to gauge the level of risk or performance of the merchant. For example, at least some loan issuing entities may only have the loan repayment as an indicator of a merchant's performance. However, many other variables factors into a merchant's performance, and also indicate the potential risk that a merchant may be unable to repay a loan in the future. It may be beneficial to have additional performance indicators in order to evaluate the risk associated with a loan to a merchant.

The ability to generate these merchant data analytics and quickly display them for the appropriate parties to consider is needed. Moreover, the ability to change the displayed analytics, and toggle back and forth for evaluation purposes is absolutely needed. This information must be displayed in real-time, and then new analytics displayed in real-time. Presenting graphical representations of information corresponding to the key business characteristics is resource intensive from a computational standpoint, for example due to the volume of data being processed and the speed with which the data needs to be retrieved and processed for the graphical representations to be displayed to a user. It may be beneficial to optimize the storage and retrieval of such data to provide a more streamlined experience for a user viewing the information.

### BRIEF DESCRIPTION

In one aspect, an analytics computing device including at least one processor in communication with at least one memory is provided. The analytics computing device is in communication with a user computing device. The at least one processor is programmed to: (a) cause a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located; (b) receive selection data corresponding to a plurality of selections made by the user via the GUI, wherein the selection data includes metrics request data associated with the plurality of merchant metrics and sector request data associated with the plurality of sectors; (c) analyze the selection data to determine (i) the requested merchant metrics of the plurality of merchant metrics that exceed a metrics request threshold and (ii) the requested sectors of the plurality of sectors that exceed a sector request threshold; (d) store a user profile in a first portion of the at least one memory including first data representing the requested merchant metrics satisfying the metrics request threshold and second data representing the requested sectors satisfying the sector request threshold; and (e) for a subsequent interaction with the GUI by the user, cause a graphical representation to be displayed via the GUI at the start of the subsequent interaction based on the user profile.

In another aspect, a computer-implemented method using an analytics computing device including at least one processor in communication with at least one memory is provided. The analytics computing device is in communication with a user computing device. The computer-implemented method includes: (a) causing a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located; (b) receiving selection data corresponding to a plurality of selections made by the user via the GUI, wherein the selection data includes metrics request data associated with the plurality of merchant metrics and sector request data associated with the plurality of sectors; (c) analyzing the selection data to determine (i) the requested merchant metrics of the plurality of merchant metrics that exceed a metrics request threshold and (ii) the requested sectors of the plurality of sectors that exceed a sector request threshold; (d) storing a user profile in a first portion of the at least one memory including first data representing the requested merchant metrics satisfying the metrics request threshold and second data representing the requested sectors satisfying the sector request threshold; and (e) for a subsequent interaction with the GUI by the user, causing a graphical representation to be displayed via the GUI at the start of the subsequent interaction based on the user profile.

In a further aspect, at least one non-transitory computer-readable storage medium having computer-executable instructions embodied thereon is provided. When executed by at least one processor of an analytics computing device comprising the at least one processor in communication with at least one memory, the analytics computing device further being in communication with a user computing device, the computer-executable instructions cause the at least one processor to: (a) cause a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located; (b) receive selection data corresponding to a plurality of selections made by the user via the GUI, wherein the selection data includes metrics request data associated with the plurality of merchant metrics and sector request data associated with the plurality of sectors; (c) analyze the selection data to determine (i) the requested merchant metrics of the plurality of merchant metrics that exceed a metrics request threshold and (ii) the requested sectors of the plurality of sectors that exceed a sector request threshold; (d) store a user profile in a first portion of the at least one memory including first data representing the requested merchant metrics satisfying the metrics request threshold and second data representing the requested sectors satisfying the sector request threshold; and (e) for a subsequent interaction with the GUI by the user, cause a graphical representation to be displayed via the GUI at the start of the subsequent interaction based on the user profile.

In one additional aspect, a method for using aggregated merchant analytics for a sector to determine a loan risk for the sector is provided. The method is implemented by a merchant analytics computing device including at least one processor in communication with a memory. The merchant analytics computing device is in communication with a user computing device. The method includes defining a plurality of sectors of a geographic region. The method also includes receiving, by the merchant analytics computing device, transaction data for financial transactions occurring within a period of time. The transaction data is associated with a plurality of merchants, and the plurality of merchants are located in the geographic region. The method further includes identifying, for each merchant of the plurality of merchants, one sector of the plurality of sectors in which the merchant is located. The method includes generating, by the merchant analytics computing device, aggregated merchant analytics for each sector based on the transaction data associated with all merchants of the plurality of merchants located in the sector. The aggregated merchant analytics represent a ranking of each sector relative to all other sectors of the plurality of sectors. In addition, the method includes determining a total pending loan amount for a subset of the plurality of sectors, each sector in the subset of sectors having at least a predetermined number of merchants having loans issued thereto, and calculating a loan risk score for each sector of the subset of sectors based upon the aggregated merchant analytics and the total pending loan amount for each sector. The method still further includes displaying, by the merchant analytics computing device, on a user interface of the user computing device, the loan risk score for each sector of the subset of sectors. The loan risk score is graphically displayed in association with a merchant loan portfolio.

In another additional aspect, a merchant analytics computing device including at least one processor in communication with a memory is provided. The merchant analytics computing device is in communication with a user computing device. The at least one processor is programmed to define a plurality of sectors of a geographic region, and receive transaction data for financial transactions occurring within a period of time. The transaction data is associated with a plurality of merchants, and the plurality of merchants are located in the geographic region. The at least one processor is also programmed to identify, for each merchant of the plurality of merchants, one sector of the plurality of sectors in which the merchant is located, and generate aggregated merchant analytics for each sector based on the transaction data associated with all merchants of the plurality of merchants located in the sector. The aggregated merchant analytics represent a ranking of each sector relative to all other sectors of the plurality of sectors. The at least one processor is further programmed to determine a total pending loan amount for a subset of the plurality of sectors, each sector in the subset of sectors having at least a predetermined number of merchants having loans issued thereto, and calculate a loan risk score for each sector of the subset of sectors based upon the aggregated merchant analytics and the total pending loan amount for each sector. The at least one processor is still further programmed to display, on a user interface of the user computing device, the loan risk score for each sector of the subset of sectors. The loan risk score is graphically displayed in association with a merchant loan portfolio.

In a further additional aspect, a computer-readable storage medium having computer-executable instructions embodied thereon is provided. When executed by a merchant analytics computing device including at least one processor in communication with a memory, the computer-executable instructions cause the merchant analytics computing device to define a plurality of sectors of a geographic region, and receive transaction data for financial transactions occurring within a period of time. The transaction data is associated with a plurality of merchants, and the plurality of merchants are located in the geographic region. The computer-executable instructions also cause the merchant analytics computing device to identify, for each merchant of the plurality of merchants, one sector of the plurality of sectors in which the merchant is located, and generate aggregated merchant analytics for each sector based on the transaction data associated with all merchants of the plurality of merchants located in the sector. The aggregated merchant analytics represent a ranking of each sector relative to all other sectors of the plurality of sectors. The computer-executable instructions cause the merchant analytics computing device to determine a total pending loan amount for a subset of the plurality of sectors, each sector in the subset of sectors having at least a predetermined number of merchants having loans issued thereto, and calculate a loan risk score for each sector of the subset of sectors based upon the aggregated merchant analytics and the total pending loan amount for each sector. The computer-executable instructions also cause the merchant analytics computing device to display, on a user interface of the user computing device, the loan risk score for each sector of the subset of sectors, wherein the loan risk score is graphically displayed in association with a merchant loan portfolio.

### BRIEF DESCRIPTION OF THE DRAWINGS

FIGS. 1-19 show example embodiments of the methods and systems described herein.

FIG. 1 is a schematic diagram illustrating an example multi-party payment card system for enabling payment-by-card transactions and generating aggregated merchant analytics in accordance with one embodiment of the present disclosure.

FIG. 2 is an expanded block diagram of an example embodiment of a computer system used in processing payment transactions that includes a merchant analytics computing device in accordance with one example embodiment of the present disclosure.

FIG. 3 illustrates an example configuration of a server system such as the merchant analytics computing device of FIG. 2.

FIG. 4 illustrates an example configuration of a client system shown in FIG. 2.

FIG. 5A is a simplified data flow diagram for generating merchant analytics using the merchant analytics computing device of FIG. 2.

FIG. 5B is a simplified data flow diagram for data organization and display using the merchant analytics computing device of FIG. 2.

FIG. 5C is a data flow diagram for data display using the merchant analytics computing device of FIG. 2.

FIGS. 6-15 are example screenshots of a user interface of a user computing device, including merchant analytics generated by the merchant analytics computing device of FIG. 2.

FIG. 16 is a simplified diagram of an example method for generating merchant analytics and displaying said analytics on a user interface using the merchant analytics computing device of FIG. 2.

FIG. 17 is a diagram of components of one or more example computing devices that may be used in the environment shown in FIG. 2.

FIG. 18 is an example portfolio record including calculated and displayed aggregated merchant analytics.

FIG. 19 is a diagram of an example method for generating merchant analytics to analyze a merchant loan risk using the merchant analytics computing device of FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

Described herein is an optimized merchant analytics computer system that includes combinations of advanced hardware configurations, memory management, and/or software optimizations, including artificial intelligence tools, to enable dynamic data storage, retrieval, and display in connection with aggregated merchant valuation analytics for a plurality of merchants located in an established or defined sector and the presentation of said analytics to a user on an interactive user interface. Moreover, the optimized merchant analytics computer system is configured to alter the display in real-time with different data analytics that allows a user to change the valuation analytics being displayed in real-time and essentially zoom in and out on a geographic map while also zooming in and out of the valuation analytics being displayed.

The systems and methods described herein are implemented by a computing device that may be referred to as a “merchant analytics computing device” or simply an “analytics computing device.” The merchant analytics computing device includes a processor in communication with a memory. In the example embodiment, the system described herein (a) causes a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located; (b) receives selection data corresponding to a plurality of selections made by the user via the GUI, wherein the selection data includes metrics request data associated with the plurality of merchant metrics and sector request data associated with the plurality of sectors; (c) analyzes the selection data to determine (i) the requested merchant metrics of the plurality of merchant metrics that exceed a metrics request threshold and (ii) the requested sectors of the plurality of sectors that exceed a sector request threshold; (d) stores a user profile in a first portion of the at least one memory including first data representing the requested merchant metrics satisfying the metrics request threshold and second data representing the requested sectors satisfying the sector request threshold; and (e) for a subsequent interaction with the GUI by the user, causes a graphical representation to be displayed via the GUI at the start of the subsequent interaction based on the user profile.

In one embodiment, the merchant analytics computing device is configured to: (a) cause a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located; (b) receive selection data corresponding to a plurality of selections made by the user via the GUI, wherein the selection data includes metrics request data associated with the plurality of merchant metrics and sector request data associated with the plurality of sectors; (c) analyze the selection data to determine (i) the requested merchant metrics of the plurality of merchant metrics that exceed a metrics request threshold and (ii) the requested sectors of the plurality of sectors that exceed a sector request threshold; (d) store a user profile in a first portion of the at least one memory including first data representing the requested merchant metrics satisfying the metrics request threshold and second data representing the requested sectors satisfying the sector request threshold; and (e) for a subsequent interaction with the GUI by the user, cause a graphical representation to be displayed via the GUI at the start of the subsequent interaction based on the user profile.

The systems and methods described herein further facilitate the generation of aggregated merchant valuation analytics for a plurality of merchants located in an established or defined sector, and the presentation of said analytics to a user on an interactive user interface. The system described herein (i) receives transaction data associated with a plurality of merchants in a geographic region; (ii) processes the transaction data to generate aggregated merchant analytics for a plurality of sectors in the geographic region, including a loan risk score representing a relative risk of offering loan(s) to merchant(s) within a sector; and (iii) presents said analytics to a user on an interactive user interface. The aggregated merchant analytics may be directed toward five key characteristics of a merchant or a sector including multiple merchants: growth, stability, size, traffic, and ticket size (and a composite or aggregation of those characteristics). The aggregated merchant analytics may also be directed towards additional metrics based upon those characteristics, such as a loan risk. In such cases, the generated aggregated merchant analytics facilitate providing additional insight and previously unavailable information to a user, with respect to the particulars of potential merchant success (e.g., ability to repay a loan) or lack thereof.

In another embodiment, the merchant analytics computing device is configured to: (i) define a plurality of sectors of a geographic region; (ii) receive transaction data for financial transactions occurring within a period of time, the transaction data associated with a plurality of merchants, the plurality of merchants located in the geographic region; (iii) identify, for each merchant of the plurality of merchants, one sector of the plurality of sectors in which the merchant is located; (iv) generate aggregated merchant analytics for each sector based on the transaction data associated with all merchants of the plurality of merchants located in the sector, wherein the aggregated merchant analytics represent a ranking of each sector relative to all other sectors of the plurality of sectors; (v) determining a total pending loan amount for a subset of the plurality of sectors, each sector in the subset of sectors having at least a predetermined number of merchants having loans issued thereto; (vi) calculating a loan risk score for each sector of the subset of sectors based upon the aggregated merchant analytics and the total pending loan amount for each sector; and (vii) displaying, by the merchant analytics computing device, on a user interface of the user computing device, the loan risk score for each sector of the subset of sectors, wherein the loan risk score is graphically displayed in association with a merchant loan portfolio.

### Sector Definition Phase

The merchant analytics computing device is configured to define a plurality of “merchant sectors,” “sector locations,” or “sectors” (used interchangeably herein). More specifically, the merchant analytics computing device is configured to divide up a geographic region (e.g., a country, state, city, county, etc.) into a plurality of sectors containing merchants therein (i.e., a subset of a plurality of merchants located within the geographic region). The sector may be defined by a geographic boundary containing the plurality of merchants therein. In an example embodiment, sectors are defined according to census blocks, and the geographic boundaries of a sector correspond to the geographic boundaries of the census block. In some embodiments, each sector includes a minimum of five merchants. Accordingly, where a sector is initially defined as a census block including fewer than five merchants, the geographic boundaries of the sector are expanded or adjusted to include at least one additional census block until the sector includes at least five merchants. In some embodiments, each sector may include up to n merchants, where n is an integer greater than five.

As described above, sectors may be defined on a geographic scale as small as a census block (which may be as small as a city block). However, sectors at the census block level may be “rolled up” or aggregated into larger, block-group level sectors, which may correspond to block groups as defined by the United States Census Bureau. Block-group level sectors may be rolled up or aggregated into large sectors, such as city- or county-level sectors, which themselves may be rolled up or aggregated into state- or nation-level sectors. The (geographic) size of the sectors may depend, in an example embodiment, on a user's view of a map on an interactive user interface, the map displaying the defined sectors. For example, is a user is viewing an entire nation, the sectors may be displayed at a state level. If the user is viewing a particular county, the sectors may be displayed at a block-group or block level.

Additionally, or alternatively, there may be one or more subsectors within any given sector, and/or any given sector that exists within a larger sector maybe referred to as a subsector. As will be further described herein, the merchant analytics computing device may be configured with specialized hardware and software and/or to utilize specialized data storage and/or processing techniques to realize improved computing efficiencies when viewing data from, for example, a sector level to a subsector level, one subsector level to another subsector level, etc. For example, the merchant analytics computing device may be configured with a dedicated local memory used exclusively for storing data at different granularity levels that match corresponding sector levels, such that when a user jumps between different sectors (e.g., changes zoom levels), only the data of the applicable sector need be retrieved from the local memory, thereby improving display speed of the data and providing a seamless backend process and frontend user experience when a user transitions the map from one sector to another. Moreover, an identifier (ID)-based organizational scheme is implemented to label and associate designated metrics with designated sectors, thereby realizing improved data retrieval, loading, and display when combined with the specialized data storage and/or processing techniques described herein.

As will be described further herein, the merchant analytics computing device is configured to determine “aggregated merchant analytics” for each sector based at least in part on received transaction data for the merchants located in the sector. The merchant analytics are indicative of the financial success of the sector relative to other sectors in that geographic region. For example, the merchant analytics computing device rank or score a sector relative to other sectors in a county or in a state. In one example embodiment, the merchant analytics computing device is configured to determine and provide merchant analytics, which may include a numerical score, for a sector based on aggregated merchant analytics for individual merchants located within the sector. For example, if a sector includes five merchants, the merchant analytics computing device may process transaction data for each individual merchant to generate analytics for each particular merchant. The merchant analytics computing device may then aggregate the individual analytics to determine “aggregated merchant analytics” for the sector as a whole. A weighted average may also be used, which may give more weight to certain merchants in the sector. Alternatively, the merchant analytics computing device may determine the aggregated merchant analytics for the sector using any other aggregation or combination of the individual merchant analytics.

The merchant analytics computing device may define or establish the sectors before receiving the transaction data. For example, the merchant analytics computing device may use available public information (e.g., census data) to define sectors, each sector including at least five merchants located therein, as described above. In some other embodiments, the merchant analytics computing device may define the sectors using the received transaction data. For example, the merchant analytics computing device may use merchant identifiers included in the transaction data to identify a location of each merchant, and then define the sectors.

The merchant analytics computing device may store transaction data, defined sectors, and/or merchant analytics (aggregated and/or individual) in a database. Each merchant for which associated transaction data and/or scores are stored may be indexed or identified in the database by at least one sector identifier and/or by merchant industry. Accordingly, the merchant analytics computing device may be configured to not only provide analytics for sectors, but may also be configured to provide analytics for particular industries and/or for particular merchants within that industry. For example, the merchant analytics computing device may generate merchant analytics for a plurality of sectors in Charlotte, North Carolina, USA, relative to other sectors in North Carolina and may generate analytics for a particular restaurant in Charlotte relative to other restaurants in the city of Charlotte, the state of North Carolina, or the United States. Moreover, a particular merchant may be indexed by (i.e., be located in) multiple sectors. For example, a merchant at Charlotte-Douglas Airport may be included in a “block” sector (named as such because such a sector may take up an area as small as a city block, in some embodiments the smallest available sector division), a “block group” sector (representative of an area that is small but that includes at least one “block” sector, for example, a census tract), a Mecklenburg County sector, a Charlotte (city) sector, a North Carolina sector, and a United States sector.

### Setup Phase

In the example embodiment, the merchant analytics computing device is configured to receive information describing a merchant in a merchant management portfolio during a configuration period referred to as a “Setup Phase”. In an example embodiment, a user (e.g., a commercial real estate owner or lender, a business owner, or marketing director) may access the merchant analytics computing device (directly or via any suitable client user computing device in communication with the merchant analytics computing device) and may provide such information. Information describing or associated with particular merchants may be referred to as “merchant definitions,” and may be used to identify and/or evaluate (e.g., score) each merchant. Merchant definitions include information associated with merchant locations including property identifiers, property location information, and merchant classification information. In addition, in the example embodiment, merchant definitions further include loan information associated with one or more merchants having a pending loan with the user (e.g., a lender). The user may also provide user preferences, such as goals for the portfolio, user preferences weighting or prioritizing certain characteristics (e.g., growth over stability), and/or alert thresholds, as described further herein.

In some implementations, merchant definitions may further include information relating to the real estate asset or property of which the merchant is a tenant (or owner), as described in co-owned U.S. patent application Ser. No. 14/564,440, the contents of which are herein incorporated by reference. For example, merchant definitions may further include pricing of a real estate asset, vacancy factors of the asset, square footage of the asset, tax information associated with the asset, and other data that may be used to adjust the analytics (e.g., valuation) of a tenant merchant and/or of a real estate asset. The user may also provide various other data associated with the user (“user data”). For example, in implementations in which the user is associated with a business (e.g., a merchant), the user may import or provide various metrics associated with the business, including budgets, marketing data, and/or goals (e.g., increase growth, increase ticket size, increase traffic).

As used herein, “merchant management portfolio” (alternately referred to as a “portfolio”) may refer to a collection of merchants in different locations but managed by or having certain elements associated with one entity or user, generally. For example, a merchant management portfolio may include a listing of all merchants having loans provided by one entity, such as a lender. In the example embodiment, a merchant management portfolio may be described by merchant definitions and/or user data and may be represented as an electronic record that may be referred to as a “merchant management portfolio record” or a “portfolio record”. Accordingly, the merchant analytics computing device processes merchant definitions and any imported user data associated with a plurality of merchants to create a portfolio record.

“Property identifiers” may include known names (or any suitable unique alphanumeric identifier) of commercial real estate assets of which a merchant is a tenant, owner, etc. (e.g., “XYZ Mall”). In an example embodiment, the merchant analytics computing device uses property identifiers to designate a location for each merchant within the portfolio record. As described below, a user may accordingly view and manage individual merchants within a portfolio distinguished by identifiers including property identifiers.

“Property location information” may include any information defining the geographic location of a merchant. In some examples, property location information may include physical addresses, geographic coordinates in latitude and longitude, elevation information (e.g., a floor or floors of a building associated with a commercial real estate asset), and any other suitable information. In some examples, property location information may include boundary information defining a physical area (or areas) containing the merchant. In an example embodiment, property location information may be used by the merchant analytics computing device to identify the merchant graphically (i.e., to provide visually mapped information showing the physical location of the merchant).

“Merchant classification information” includes information categorizing the merchant within categories that may be relevant to the monitoring of the value of the merchant. For example, merchant classification information may categorize a merchant according to a particular industry, location, or other classification, for example, “retail”, “office”, “warehouse”, “manufacturing”, “healthcare,” “outdoor mall”, “indoor mall” and any other suitable information.

“Loan information” includes information describing loans provided to any merchant(s) within a merchant management portfolio. For example, loan information for a merchant may include a pending loan amount for that merchant (i.e., the amount of a loan still owed to the lender from the merchant), a total loan amount (i.e., a total amount lent to the merchant by the lender), a repayment schedule (which may include both future anticipated payments and past dates/amounts of payment already made), interest rates, and/or any other information associated with the loan. Loan information may further include aggregate information for two or more loans for one or more merchants within the merchant management portfolio. For example, loan information may include a total pending loan amount for all outstanding loans to all merchants within the portfolio.

The merchant analytics computing device may also generate a unique portfolio identifier in the Setup Phase to identify the portfolio record. Accordingly, a user device (operated by a user) may provide such a portfolio identifier at a later point in time and retrieve the portfolio record to review or monitor portfolio defined by the portfolio record.

In at least some examples, the user data received by the merchant analytics computing device includes a plurality of investment goals associated with each merchant and/or with the portfolio. At least some parties associated with the portfolio (e.g., commercial owners or lenders, marketing directors, investors, managers) may have varying financial goals for a portfolio. Because investors and lenders may vary in their underlying interests, the merchant analytics computing device may be configured to monitor merchants pursuant to such investment goals. For example, the merchant analytics computing device may be configured to identify certain merchants meeting or exceeding the investment goals and other merchants not meeting the investment goals, such that the investors may make financial decisions regarding the relative worth or success of the various merchants. The merchant analytics computing device may be further configured to provide information (e.g., loan risk scores, described further herein) indicating to the user (e.g., a lender or investor) the relative risk of lending to a merchant (e.g., the relative risk associated with an existing loan and/or the relative risk of providing a new loan to a merchant) based upon the relative financial success of the merchant. The user data may also include various specifications descriptive of existing merchants and/or merchant locations in the portfolio or descriptive of merchants and/or merchant locations outside of the portfolio (in the case of a commercial real estate broker looking to buy, rent, or lease a merchant location).

In one particular example, a business may own, or otherwise be associated with, multiple merchants at multiple merchant locations. A user interested in the marketing money invested in the various merchants (e.g., a marketing director or Chief Marketing Officer) may import investment goals to the merchant analytics computing device that accord with the goals of the business. For example, the user may have a marketing budget of $500 million. The investment goals may prioritize the merchants with the highest growth, such that a higher percentage of the marketing budget may be spent near those merchants. The investment goals may alternatively prioritize merchants with the highest traffic, highest ticket size, or highest stability. Accordingly, as will be described further herein, the merchant analytics computing device may use the investment goals to identify the merchant(s) with the strongest merchant analytics (e.g., highest scores) to the user.

In another particular example, a lender (e.g., a bank) may provide loans to a plurality of merchants at multiple merchant locations. A user interested in determining the relative risk of a merchant loan may import loan information and lending goals to the merchant analytics computing device. The lending goals may identify metrics associated with merchants and/or loans that the lender considers either positive or negative, such that those merchants or loans having associated metrics falling within the positive or negative thresholds or ranges will be identified to the user. Accordingly, as will be described further herein, the merchant analytics computing device may use the lending goals to identify the merchant(s) with the highest and/or the lowest likelihood of successfully repaying loans provided by the user.

In addition, the user may provide alert thresholds or other alert preferences to the merchant analytics computing device. The alert thresholds may set a specific threshold, such that when a score falls below (or above, depending on the scale of a score) that threshold, the merchant analytics computing device generates an alert the user. The alert may be transmitted to the user in any format. In one example embodiment, the alert is transmitted in a control message that causes a user computing device of the user to activate and display the alert to the user.

### Evaluation Phase

In an example embodiment, the merchant analytics computing device generates analytics (e.g., a score) associated with a merchant or a sector in a process that may be referred to as the “Evaluation Phase”. The merchant analytics computing device is configured to generate the analytics based on received transaction data associated with the merchant or sector. As used herein, “transaction data” may include transaction amounts, merchant identifiers, account identifiers, associated time and date stamps, and data descriptive of the product(s) purchased. Merchant identifiers may include an identifier of the merchant at which the transaction was initiated as well as an identifier of the physical location (e.g., a street address, geographic coordinates, etc.) of the merchant.

In the example embodiment, the merchant analytics computing device receives transaction data from a payment processor integral to or associated with a payment processing network. In some embodiments, the transaction data is anonymized and aggregated by merchant prior to receipt by the merchant analytics computing device (i.e., no personally identifiable information (PII) is received by the merchant analytics computing device). In other embodiments, the merchant analytics computing device may be configured to receive transaction data that is not yet anonymized and/or aggregated, and thus may be configured to anonymize and aggregate the transaction data. In such embodiments, any PII received by the merchant analytics computing device is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

The merchant analytics computing device may generate multiple merchant analytics for each merchant and may generate “aggregated merchant analytics” for each sector. Aggregated merchant analytics refer generally to an average, weighted average, or any other aggregation of individual merchant analytics generated for merchants located in the sector. For example, the “merchant analytics” may include at least one of a growth score, a stability score, a size score, a ticket size score, a traffic score, and a composite score for each sector. A “growth score” is a ranking of the growth of the sector relative to other sectors in the geographic region, wherein “growth” refers generally to sales revenue growth over a period of time. A “stability score” is a ranking of the stability of the sector, wherein “stability” refers generally to a maintenance of sales revenue within a range of sales revenues around an average. A “size score” is a ranking of the size of the sector, wherein “size” refers generally to total sales revenue. A “traffic score” is a ranking of the traffic of the sector, wherein “traffic” refers generally to a number of monthly transactions. A “ticket size score” is a ranking of the ticket size of the sector, wherein “ticket size” refers generally to a transaction amount, and may be calculated by dividing the size by the traffic (i.e., dividing sales revenue by the number of transactions). A “composite score” is a composite of the previous five scores (growth, stability, size, traffic, and ticket size), to provide an overall ranking of the sector.

A “loan risk score” is a ranking of a relative risk of the sector or relative likelihood of merchants within the sector repaying loans provided thereto. The loan risk score may be calculated by leveraging one or more of the above-described scores and pending loan amounts for merchants having pending loans within the sector. For example, sectors having high traffic scores and/or high growth scores may have a low loan risk score representing a low risk for lending to a merchant in that sector, as the merchant is likely to exhibit high traffic and/or high growth. If that same sector has a high pending loan amount, however, the loan risk score may be relatively higher, indicating that there is a high outstanding amount of money due from merchants in that sector and it may not be an effective strategy to continue to lend to merchants all within the same area. It should be understood that the relative effect of certain scores on a loan risk score may vary depending on the user (e.g., based upon lending goals, investment goals, etc.). For instance, a first user (e.g., lender or investor) may choose to prioritize or weight stability over size, and a second user may choose to prioritize growth over ticket size.

In the example embodiment, the loan risk score is calculated based upon at least one other score for a sector and a total pending loan amount for merchants having loans within that score. For example, a loan risk score for one sector within a portfolio may be calculated using Equation 1:

$$Loan risk score = Loan Amount Pending for a sector ( as a percentage of a Total Loan Amount ) * ( Average “ Base Score ” over portfolio / “ Base Score ” for a sector ) / Average Loan Amount Pending over portfolio \qquad ( 1 )$$

The “Base Score” represents one or more of the above-described scores (e.g., growth, size, traffic, ticket size, stability, composite). Calculating the loan risk score using Equation 1 may be generally described as multiplying the total pending loan amount for a sector by a normalization of the “Base Score” for the sector (e.g., an average of the “Base Score” divided by the individual

“Base Score”) and dividing by an average pending loan amount for all sectors. In one particular example, a loan score may be calculated based upon growth (e.g., for a user that has prioritized high growth within a sector as the most important characteristic of that sector). In such an example, the “Base Score” in Equation 1 would be the growth score. It should be understood that Equation 1 is illustrative only and any number of equation, models, or algorithms may be used to calculate a loan risk score based upon one or more other scores.

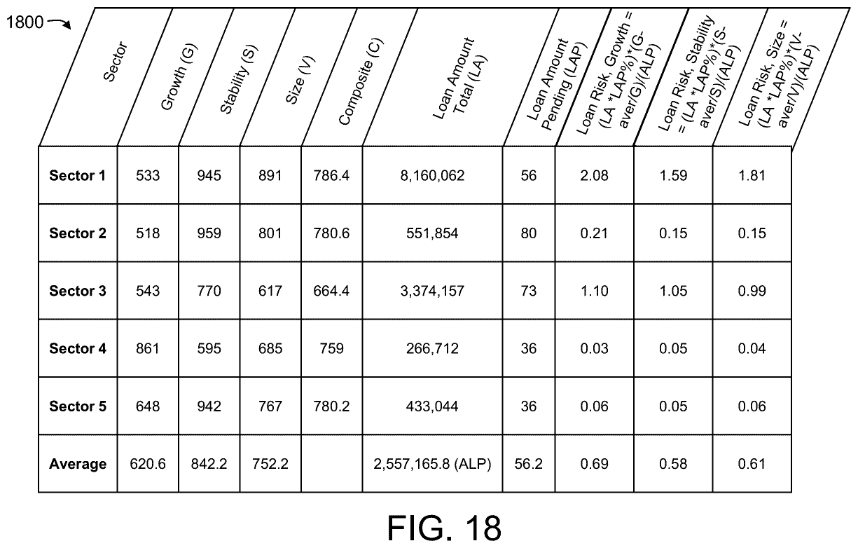

For example, FIG. 18, which is described below, illustrates one example of a lender portfolio 1800. In this example, the portfolio 1800 includes merchant loans within ten sectors (Sector 1 through Sector 10). Growth, Stability, and Size Scores are all computed and displayed (as described herein) for the sectors. The Composite Score, in this particular example, is an average of the previous five scores (although Traffic and Ticket Size Scores are not shown in the example Table). The portfolio 1800 also includes Total Loan Amount for each sector, and a Loan Amount Pending for the sector (represented as a percentage of the Total Loan Amount). Loan risk scores based upon growth, stability, and size are all calculated according to Equation 1.

In certain embodiments, the portfolio may be sorted or optimized (as described herein) to display sectors with lower or higher risk at the top of the portfolio. Additionally or alternatively, the displayed loan risk scores (and/or other scores) may be color-coded or otherwise visually identified based upon the relative loan risk score. For instance, scores higher than an average loan risk score may be highlighted in red, indicating higher relative risk, whereas scores lower than an average loan risk score may be highlighted in green, indicating lower relative risk. Various gradations of color (e.g., lighter red vs. darker red) may further indicate relative risk.

Where the general term “score” without a modifier is used herein, it may refer collectively to any or all of the preceding scores to describe characteristics shared by some or all of the scores. Each of these scores (collectively “analytics”) may be generated for each merchant within a sector and may be subsequently aggregated to generate aggregated merchant analytics for the sector.

In the example embodiment, a score may be normalized to be between 0 and 1,000. In some embodiments, a higher score indicates a “better” sector (i.e., a higher relative ranking). For example, a sector with a score of 800 may rank higher on any or all of the above-described factors than a sector with a score of 300. Some scores, such as the loan risk score, may not be normalized. Moreover, a higher score may indicate a “worse” sector (i.e., a lower relative ranking). For example, a sector with a loan risk score of 0.5 may have a lower relative loan risk than a sector with a loan risk score of 1.0. A “better” sector refers to a sector that is preferred over other sectors (or is performing better) based upon the financial transactions performed at merchants located within that sector.

In the example embodiment, the merchant analytics computing device receives transaction data associated with merchants that spans a period of time. For example, the merchant analytics computing device may receive and process transaction data for a merchant or sector that spans between one month and at least two years prior to the date of receipt. Accordingly, the merchant analytics computing device may generate the analytics as functions of time. For example, a growth score would be meaningless if there were no transaction data for a past date from which to determine relative growth. In the example embodiment, the merchant analytics computing device generates analytics for each merchant and/or sector using 12 months' or one year's worth of transaction data for the merchant and/or sector. Accordingly, a growth score is representative of the growth of the sector over the past year, the stability score is representative of the stability of the sector over the past year, etc. In other embodiments, the merchant analytics computing device may be further configured to determine a “spot” score of any of the above-described scores, wherein a “spot” score refers generally to a score calculated for a shorter period of time, for example, three months as opposed to twelve months. The spot score may be used to determine changes in the characteristics of the merchant over a short period of time that may be masked or hidden when scoring the merchant over a year. For example, if a merchant debuted a new, highly anticipated product two months ago, a dramatic increase in sales growth over those two months may be dulled by looking at the full year's growth. As another example, if a sector (e.g., a particular city neighborhood) enacted multiple marketing campaigns over the course of a year, it may be difficult to determine which particular campaign was the most effective in increasing traffic, if the entire years' worth of transaction data is used to score the sector.

In one embodiment, the merchant analytics computing device may determine a growth score for a merchant using the received transaction data over a period of time (e.g., a year). The merchant analytics computing device determines the increase or decrease in the sales revenue for the merchant over that year based on the aggregation of all of the transaction data associated with the merchant. Additionally or alternatively, the growth for a merchant may be calculated by fitting total sales revenue to a regression line and tracking resulting slopes. Additionally or alternatively, quarterly sales revenue (i.e., 3-months' worth of sales revenue data) may be calculated and compared to the corresponding quarter of the previous year. As the growth score is a relative ranking, the merchant analytics computing device may compare the determined growth of each merchant prior to providing the numerical growth score for each merchant. The merchant analytics computing device may then use the growth scores of all of the merchants in a sector to determine an aggregated growth score for the sector (e.g., an average or weighted average of the merchant growth scores for the merchants within the sector). Alternatively, the merchant analytics computing device may use the determined growth of each merchant in a sector to determine an aggregated growth score for the sector and may subsequently compare sectors. The merchant analytics computing device may then provide the (numerical) growth score for the sector.

In one embodiment, the merchant analytics computing device may determine a stability score for a merchant using the received transaction data over a period of time (e.g., a year). The stability of a merchant is a metric or analytic of the volatility of the merchant's cash flow. The merchant analytics computing device may determine an average sales revenue for the merchant over a year or may receive an average sales revenue for the merchant (which may be an “expected” average sales revenue or other value received from a user associated with the merchant or may be retrieved from a database). The merchant analytics computing device may then determine a range around that average (e.g., one standard deviation, a certain percentage or fraction of the average, or any other suitable range) which indicates stable sales revenue. Using aggregated transaction data, the merchant analytics computing device identifies whether the merchant had sales revenue within that range. Falling outside of the range indicates less stable sales revenue and lowers the ranking of the merchant in terms of stability. The merchant analytics computing device may use monthly transaction data to determine, at each month, whether the merchant had sales revenue within the predetermined range. Alternatively, the merchant analytics computing device may use transaction data from any other interval (i.e., each week, every two weeks, over the year, etc.) to determine the stability of the sales revenue of the merchant. As the stability score is a relative ranking, the merchant analytics computing device may compare the determined stability of each merchant prior to providing the numerical stability score for each merchant. The merchant analytics computing device may then use the stability scores of all of the merchants in a sector to determine an aggregated stability score for the sector (e.g., an average or weighted average of the merchant stability scores for the merchants within the sector). Alternatively, the merchant analytics computing device may use the determined stability of each merchant in a sector to determine an aggregated stability score for the sector and may subsequently compare sectors. The merchant analytics computing device may then provide the (numerical) stability score for the sector.

In one embodiment, the merchant analytics computing device may determine a size score for a merchant using the received transaction data associated with the merchant over a period of time (e.g., a year). The size metric or analytic may be considered a proxy analytic for how large a particular merchant or business is. The merchant analytics computing device may aggregate the total sales revenue for the merchant for each month in the year, or over the whole year. As the size score is a relative ranking, the merchant analytics computing device may compare the determined size of each merchant prior to providing the numerical size score for each merchant. The merchant analytics computing device may then use the size scores of all of the merchants in a sector to determine an aggregated size score for the sector (e.g., an average or weighted average of the merchant size scores for the merchants within the sector). Alternatively, the merchant analytics computing device may use the determined size of each merchant in a sector to determine an aggregated size score for the sector and may subsequently compare sectors. The merchant analytics computing device may then provide the (numerical) size score for the sector.

In one embodiment, the merchant analytics computing device may determine the traffic score for a merchant using the received transaction data over a period of time (e.g., a year). The merchant analytics computing device may identify a number of transactions completed at the merchant for the entire year to determine the traffic for the merchant, or may identify the number of transactions for each month in the year. Additionally or alternatively, other data may be used to determine the traffic at a merchant, including mobile device signal data, as described in co-owned U.S. patent application Ser. No. 14/708,020, the contents of which are hereby incorporated by reference. As the traffic score is a relative ranking, the merchant analytics computing device may compare the determined traffic of each merchant prior to providing the numerical traffic score for each merchant. The merchant analytics computing device may then use the traffic scores of all of the merchants in a sector to determine an aggregated traffic score for the sector (e.g., an average or weighted average of the merchant traffic scores for the merchants within the sector). Alternatively, the merchant analytics computing device may use the determined traffic of each merchant in a sector to determine an aggregated traffic score for the sector and may subsequently compare sectors. The merchant analytics computing device may then provide the (numerical) traffic score for the sector.

In one embodiment, the merchant analytics computing device may determine a ticket size score for a merchant using the received transaction data over a period of time (e.g., a year) and/or using the determined size and traffic for the merchant. The ticket size (also referred to herein as an “average ticket size”) enables improved visibility into the types of merchant in a sector. A low average ticket size, for example, around $5, may indicate a sector includes restaurants or coffee shops. A higher average ticket size, for example, around $2,000, may indicate a sector includes jewelry stores, electronics merchants, or furniture stores. The merchant analytics computing device may calculate the ticket size for the merchant by dividing a sales revenue of the merchant by a number of transactions. Alternatively, the merchant analytics computing device may calculate the ticket size by dividing a size of the merchant as determined above, by a traffic of the merchant, as determined above. As the ticket size score is a relative ranking, the merchant analytics computing device may compare the determined ticket size of each merchant prior to providing the numerical ticket size score for each merchant. The merchant analytics computing device may then use the ticket size scores of all of the merchants in a sector to determine an aggregated ticket size score for the sector (e.g., an average or weighted average of the merchant ticket size scores for the merchants within the sector). Alternatively, the merchant analytics computing device may use the determined ticket size of each merchant in a sector to determine an aggregated ticket size score for the sector and may subsequently compare sectors. The merchant analytics computing device may then provide the (numerical) ticket size score for the sector.

In one embodiment, the merchant analytics computing device may determine a composite score for a merchant based on the growth, stability, size, traffic, and/or ticket size score for the merchant. The composite score may be an average of all five scores, may be a weighted average of all five scores, or may be any other combination or aggregation of the five scores for the merchant location. The composite score for a sector may be an average of all five scores, may be a weighted average of all five scores, or may be any other combination or aggregation of the five scores for the sector (e.g., an average or weighted average of the merchant composite scores for the merchants within the sector). Alternatively, the composite score for a sector may be an average, weighted average, or any other aggregation of the composite scores of the merchants in the sector. The composite score is intended to be an “at-a-glance”ranking of the relative success of the sector, taken as a function of the five identified characteristics that may reflect the success of a business.

In one embodiment, the merchant analytics computing device may determine a loan risk score for a merchant using the received transaction data over a period of time (e.g., a year) as well as loan information input to the merchant analytics computing device by a user (e.g., a manager of a merchant loan portfolio). More particularly, the merchant analytics computing device determines the loan risk score using one or more already-determined scores (described above), the loan information, and other input from the user. The merchant analytics computing device accesses one or more user preferences to build an algorithm that weights one or more of the scores and the pending loan information according to the user preferences. In some embodiments, the merchant analytics computing device may access a default algorithm if the user has not provided user preferences or provides conflicting user preferences. The merchant analytics computing device may access one or more rules that define how to build a custom algorithm or when to use a default algorithm based upon the received user preferences. The loan risk score facilitates improved visibility into the potential risk of lending to a merchant, or a relative likelihood that the merchant will successfully repay a loan. The loan risk score may be applied to existing merchants' loans, such that a lender or investor has a more thorough picture of repayment risk of existing loans. Additionally or alternatively, the loan risk score may be applied to new merchant loans, such that a lender or investor may have another data point to use in determining whether a loan should be provided to a merchant within a particular sector. The loan risk score may be determined for sectors including a threshold number of merchants already having loans provided thereto.

In some embodiments, the merchant analytics computing device may be configured to generate and store merchant analytics for a merchant and/or a sector over multiple periods of time. For example, the merchant analytics computing device may initially generate a score based on data having timestamps from Jun. 1, 2013-Jun. 1, 2014 and may store that score as Score 1. The merchant analytics computing device may then generate a score based on data having timestamps from Jul. 1, 2013-Jul. 1, 2014, and may store that score as Score 2. The merchant analytics computing device may store N scores (or any other analytics) for a merchant and/or a sector, wherein N is an integer greater than one. Accordingly, the merchant analytics computing device may store a time series of scores (or any other analytics) for a merchant and/or a sector, which collects all N scores for the merchant and/or the sector sequentially (i.e., in order of time, from oldest to newest). In such embodiments, the merchant analytics computing device may use multiple scores to generate score trends.

In one embodiment, the merchant analytics computing device may update a portfolio record with any or all of the analytics for a merchant and/or any or all aggregated merchant analytics for a sector in which the merchant is located. The merchant analytics computing device may be configured to determine analytics for the portfolio as a whole, using the generated analytics for each merchant in the portfolio and/or each corresponding sector. The merchant analytics computing device may be further configured to sort the merchants in a portfolio based on the investment goals for the portfolio. For example, if an investment goal identifies growth as a priority, the merchant analytics computing device may sort the merchant records in the portfolio record according to highest growth score. If there are no investment goals or if there are conflicting investment goals, the merchant analytics computing device may sort the merchant records in the portfolio according to highest composite score. As another example, the merchant analytics computing device may sort the merchants according to the loan risk score, identifying the riskiest sectors or merchants therein first to indicate to the user those merchants that may be least likely to repay outstanding loans.

### Optimization Phase

The system is also configured to facilitate optimization of portfolios in an “Optimization Phase.” In one example, the system is configured to sort the merchant records in the portfolio according to the goals (e.g., investment goals) of a user. As described briefly above, some users may be responsible for or otherwise interested in a distribution of a marketing budget according to the investment goals, in some cases prioritizing growth or traffic or stability, as desired. If the user (a CMO, in this example, for illustrative purposes only) has a specific, predetermined budget and predetermined investment goals, the system may enable the CMO to distribute the budget based on the evaluation of all of the merchants in the CMO's portfolio. If, for example, the CMO chose to prioritize growth in his/her investment goals for his/her associated business, the system may sort the merchant location records in the portfolio from highest growth score to lowest growth score and may present the results as a list. In some implementations, the CMO may import more specific investment goals to the system. For example, the CMO may indicate that 15% of his/her budget is to be spent on the top 5% of merchants in the portfolio with the highest growth. The next 15% is to be spent on the 10% of merchants with the next-highest growth. The next 10% is to be spent on the 10% of the merchants with the next-highest growth, and so on and so forth. The system may use these specific investment goals and output an optimized portfolio record that divides the merchant records into the desired percentiles.

In another example, the system is configured to provide recommendations for new locations for merchants using existing merchant records in a portfolio. In this example, a user (a real estate broker, for illustrative purposes only) may have received an offer from a merchant to rent (or lease) a merchant location (e.g., a property or a portion of a property). The merchant may have a particular sector in mind, or may have indicated in the offer that he/she desires a merchant location having certain specifications (e.g., a merchant location in a high-traffic sector). The real estate broker may import the specifications into the system, which may output an optimized portfolio to the real estate broker including sector records of sectors including available merchant locations having the specifications. Alternatively, the real estate broker may use the system to locate and/or suggest a sector other than the particular sector identified in the offer, by illustrating (using a user interface provided by the system) higher performance (e.g., higher traffic or higher growth) in a different sector. In another related example, the real estate broker may have an existing client complaining of poor performance at his/her merchant location. The real estate broker may illustrate (using the user interface provided by the system) slowing growth or traffic trends in the client's current sector, and may suggest relocation to a sector with higher recent performance.

In yet another example, the system is configured to provide recommendations to a user on whether or not to offer a loan to a merchant. In this example, the user (a lender or investor, for illustrative purposes only) may have received a request from a merchant for a loan. The merchant is located in a particular sector, wishes to relocate or add a location in that sector, and/or is determining a sector to relocate to/add a location in. The lender may import specifications of the loan and/or particular loan repayment specifications into the system, which may output an optimized portfolio to the lender including sector loan risk scores that leverage outstanding and/or completed (i.e., repaid) loans from merchants within particular sectors. The optimized portfolio may highlight (e.g., by placing at the top of a sector list) a sector with strong growth and high traffic that has a loan risk score indicating a low risk for lending to or investing in a merchant in that sector. The optimized portfolio may display detailed aggregated merchant analytics for the merchant's current sector, as compared to one or more other sectors, such that the lender may have a perspective on the relative loan risk in one sector compared to other sectors.

### User Interface

The merchant analytics computing device is further configured to facilitate the display of an interactive graphical user interface (UI). The UI may be displayed on a user computing device of a user. The UI is configured such that the user may easily view aggregated merchant analytics for a sector and/or for a particular industry, for example, as a graphical representation displayed relative to a portfolio (e.g., as a table) and/or on a map. In one embodiment, the UI is populated with data that is updated on a monthly basis, however, in other embodiments, the UI may be populated with data updated at any other interval (e.g., weekly, daily, etc.).

In the example embodiment, the user may search by location to find a geographic region (e.g., state, city, zip code, zip+4, county, neighborhood) in which the user is interested. The UI displays the geographic location on a map divided into defined sectors. In some embodiments, the UI enables a user to “zoom in” and “zoom out” on the view. Zooming in may provide a view of the sectors at a more granular level. Zooming out may provide a view of sectors aggregated into larger geographic regions, for example, by city, county, or state. In the example embodiment, displayed sectors are colored or shaded according to the strength of generated merchant analytics, wherein a darker or more saturated color or shade indicates stronger analytics (e.g., more successful sectors). Accordingly, the user may easily discern sectors with stronger analytics, with only a single glance. In other embodiments, lighter colors may indicate stronger analytics. In still other embodiments, the sectors may not be colored or shaded at all.

As will be described further herein, the UI may provide to user an option to view sectors according to different metrics (e.g., according to the various scores described above included within the merchant analytics). The UI may also allow the user to switch between a “street map” view, in which the divisions of defined sectors are overlaid upon a traditional street map, and a “satellite view”, in which the defined sectors are overlaid upon satellite imagery of the geographic region. Accordingly, depending on the view, users may be able to more easily understand the delineations between sectors and the geographical advantages that may serve certain sectors over others. In addition, as will be described further herein, the UI may provide other tools to the user for navigation of the merchant analytics and for a “deeper dive” into the granularity of the analytics.

The systems and methods herein are configured to leverage transaction data and loan information and perform calculation therewith that were previously inaccessible and/or not performed by other systems. Specifically, the systems and methods herein facilitate providing insight into merchant performance in an anonymous and/or aggregated fashion, using sector analytics that obscure individualized data while still enhancing a user's knowledge of a merchant's potential and/or likely performance. Accordingly, the systems and methods are configured to provide at least one of the following technical effects: (a) integration of transaction data into the generation of merchant analytics by linking transaction data received from interchange networks (or payment networks) to such analytics, (b) improvement of the visualization of sector value or success, relative to other sectors and over time, (c) optimization of investment by using objective evaluations of relative success of certain sectors and/or merchants over others, (d) improvement of the retrieval and storing of data from/in data structures and memories for real-time retrieval, display, modification of the data, and re-display of the modified data, and/or (e) improvement of the real-time display of graphical information and the re-display of modified or altered graphical information.

The technical effects of the systems and methods described herein can be achieved by performing at least one of the following steps: (i) defining a plurality of sectors of a geographic region; (ii) receiving transaction data for financial transactions occurring within a period of time, the transaction data associated with a plurality of merchants, the plurality of merchants located in the geographic region; (iii) identifying, for each merchant of the plurality of merchants, one sector of the plurality of sectors in which the merchant is located; (iv) generating aggregated merchant analytics for each sector based on the transaction data associated with all merchants of the plurality of merchants located in the sector, wherein the aggregated merchant analytics represent a ranking of each sector relative to all other sectors of the plurality of sectors; (v) determining a total pending loan amount for a subset of the plurality of sectors, each sector in the subset of sectors having at least a predetermined number of merchants having loans issued thereto; (vi) calculating a loan risk score for each sector of the subset of sectors based upon the aggregated merchant analytics and the total pending loan amount for each sector; (vii) displaying, by the merchant analytics computing device, on a user interface of the user computing device, the loan risk score for each sector of the subset of sectors, wherein the loan risk score is graphically displayed in association with a merchant loan portfolio; (viii) implementing artificial intelligence tools to streamline and optimize data labelling, data retrieval, data storage, and display of data from memory based on learned usage patterns, and/or (ix) dynamically updating data structures and/or memory storage locations based on learned usage patterns, and cause data analytics to be retrieved in real-time and displayed on a user interface and then altered in real-time for a re-display of the altered data analytics.

The following detailed description of the embodiments of the disclosure refers to the accompanying drawings. The same reference numbers in different drawings may identify the same or similar elements. Also, the following detailed description does not limit the claims.

Described herein are computer systems such as merchant analytics computing devices and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the generation and communication (e.g., display) of aggregate merchant valuation analytics.

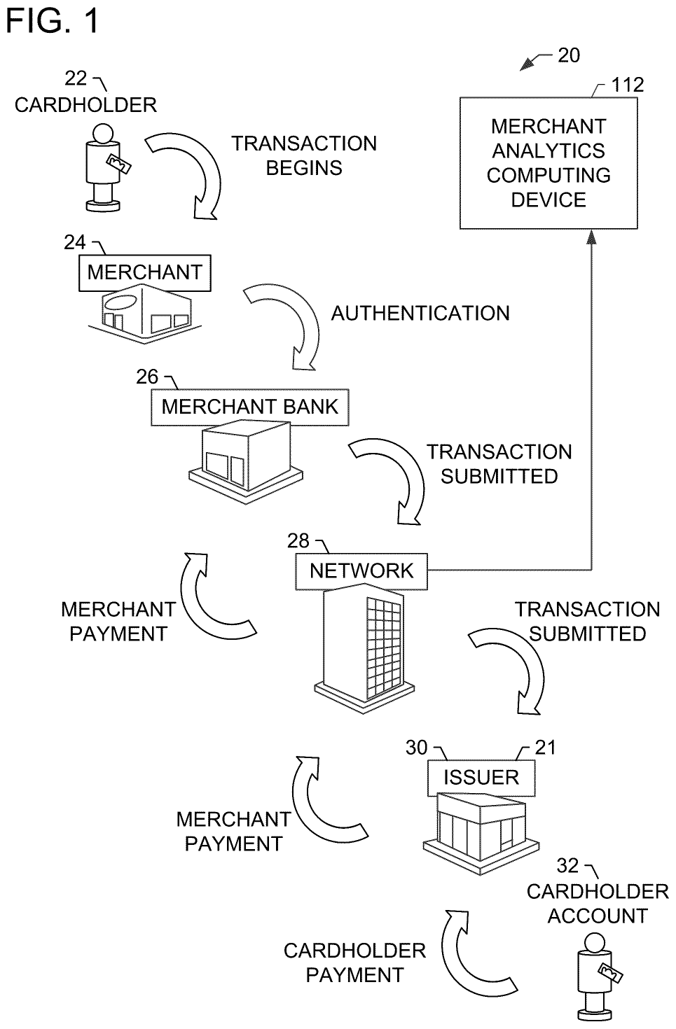

FIG. 1 is a schematic diagram illustrating an example multi-party payment card system 20 for enabling payment-by-card transactions to facilitate generating aggregated merchant analytics for a sector, in accordance with one embodiment of the present disclosure. FIG. 1 depicts a flow of data in a financial transaction through system 20, which includes a merchant analytics computing device 112. Components of system 20 provide merchant analytics computing device 112 with transaction data, which merchant analytics computing device 112 processes to generate merchant analytics and provide the analytics on a user interface.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

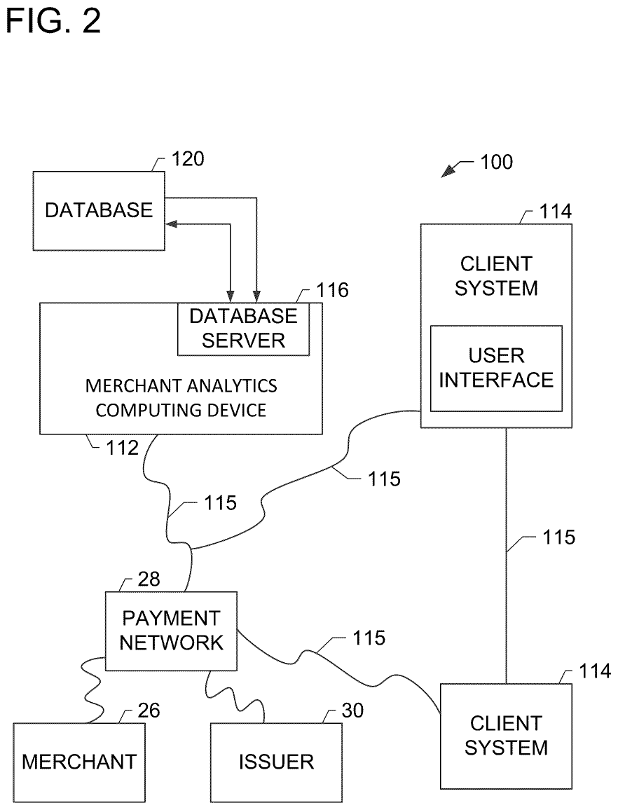

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including merchant analytics computing device 112. In the example embodiment, interchange network 28 provides such transaction data (including merchant data associated with merchant tenants of each commercial real estate asset of each portfolio record) and additional transaction data. In alternative embodiments, any party may provide such data to merchant analytics computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, merchant analytics computing device 112 may be used to generate and communicate aggregated merchant analytics. Although the systems described herein are not intended to be limited to facilitate such applications, the systems are described as such for exemplary purposes.

FIG. 2 is an expanded block diagram of an example embodiment of a computer system 100 used in processing payment transactions that includes merchant analytics computing device 112 in accordance with one example embodiment of the present disclosure. In the example embodiment, system 100 is used for generating merchant analytics and displaying said analytics on a user interface, as described herein.

More specifically, in the example embodiment, system 100 includes a merchant analytics computing device 112, and a plurality of client sub-systems, also referred to as client systems 114, connected to merchant analytics computing device 112. In one embodiment, client systems 114 are computers including a web browser, such that merchant analytics computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store data. Merchant analytics computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on merchant analytics computing device 112 and can be accessed by potential users at one of client systems 114 by logging onto merchant analytics computing device 112 through one of client systems 114. In an alternative embodiment, database 120 is stored remotely from merchant analytics computing device 112 and may be non-centralized. Database 120 may be a database configured to store information used by merchant analytics computing device 112 including, for example, transaction data, defined sectors, merchant definitions, user data, portfolio records, merchant scores, and sector scores.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data. Database 120 may additionally store loan information, portfolio information, and/or user information.

In the example embodiment, one of client systems 114 may be associated with one of acquirer bank 26 (shown in FIG. 1) and issuer bank 30 (also shown in FIG. 1). For example, one of client systems 114 may be a POS device. Client systems 114 may additionally or alternatively be associated with a user (e.g., a commercial real estate owner or lender, a marketing director, a consumer, or any other end user). In the example embodiment, one of client systems 114 includes a user interface 118. For example, user interface 118 may include a graphical user interface with interactive functionality, such that aggregated merchant analytics, transmitted from merchant analytics computing device 112 to client system 114, may be shown in a graphical format. A user of client system 114 may interact with user interface 118 to view, explore, and otherwise interact with the merchant analytics. Merchant analytics computing device 112 may be associated with interchange network 28 and/or may process transaction data.

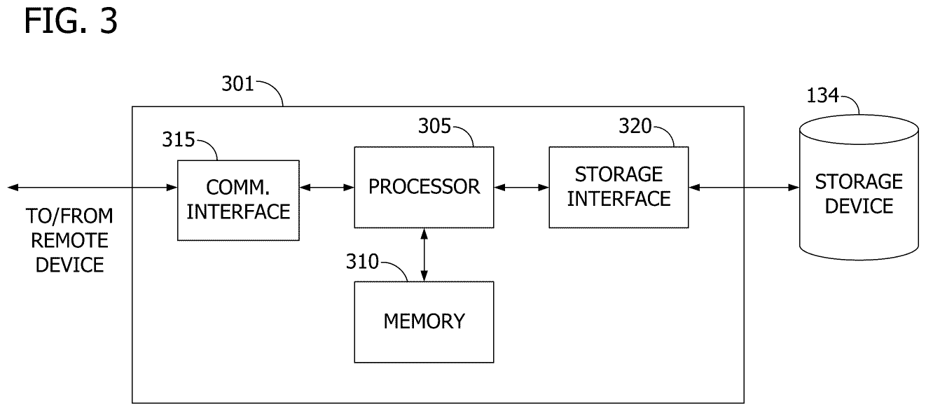

FIG. 3 illustrates an example configuration of a server system 301 such as merchant analytics computing device 112 (shown in FIGS. 2 and 3) used to generate merchant analytics and present said analytics on an interactive user interface, in accordance with one example embodiment of the present disclosure. Server system 301 may also include, but is not limited to, database server 116. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to display merchant analytics and/or provide an interactive user interface) from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134.

Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

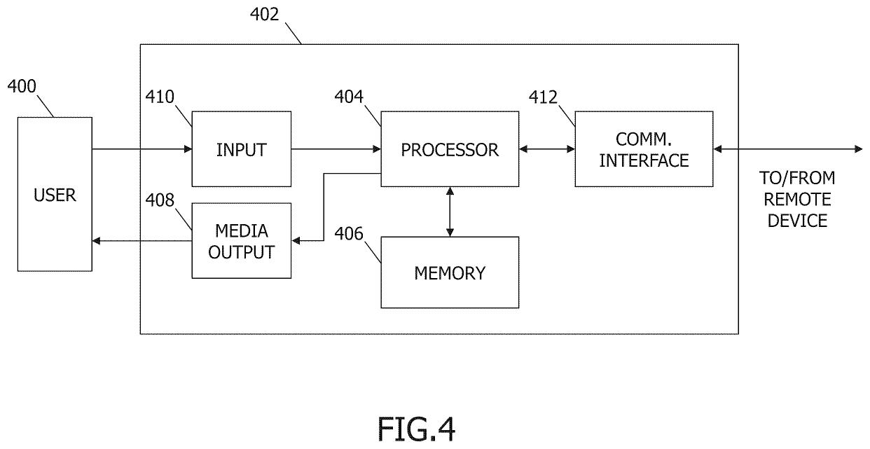

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400 (e.g., a cardholder 22). Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 302 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server associated with a merchant. A client application allows users 400 to interact with a server application associated with, for example, a merchant. The user interface, via one or both of a web browser and a client application, facilitates display of generated merchant analytics by merchant analytics computing device 112. The user may interact with the user interface to view and explore the merchant analytics, for example, by selecting a sector of interest using input device 410 and viewing analytics associated with that sector.

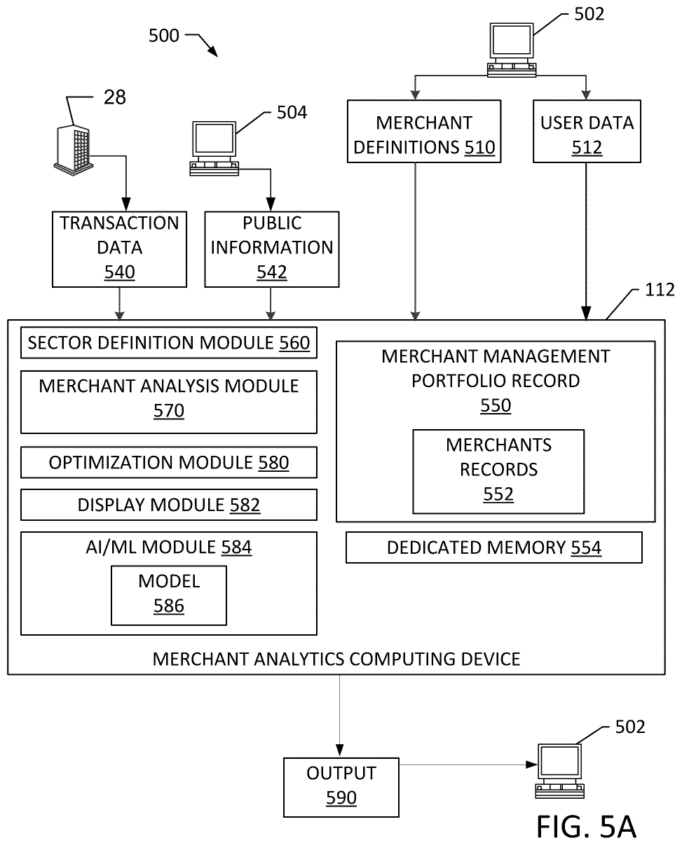

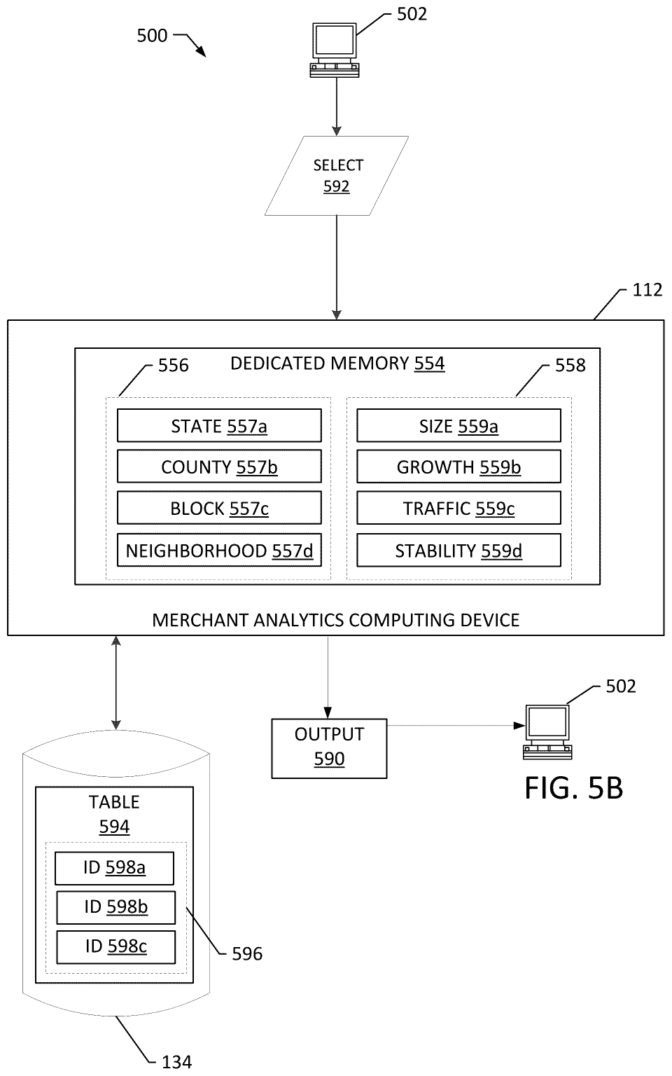

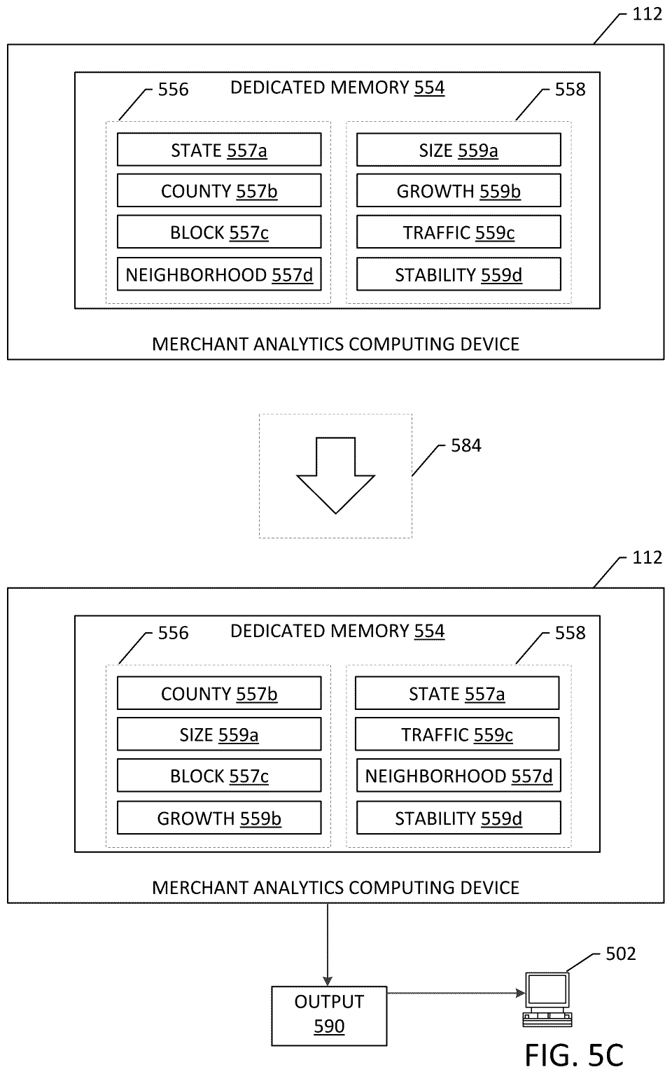

FIG. 5A is a simplified data flow diagram for generating aggregated merchant analytics for a sector, and providing the analytics for display on a user interface using merchant analytics computing device 112. As described herein, merchant analytics computing device 112 receives merchant definitions 510 (such as portfolio loan information, including information about pending loans) and user data 512 (such as lending or investment goals) from a user device 502 (such as a commercial lender, a commercial owner, an investor, or a marketing director). Merchant analytics computing device 112 defines a plurality of merchant records 552 based on merchant definitions 510 in the Setup Phase as identified above and herein. Merchant analytics computing device 112 further defines merchant management portfolio record 550 based on such merchant definitions 510.

Merchant analytics computing device 112 also receives transaction data 540 associated with a plurality of merchants being analyzed. Transaction data 540 may be received from interchange network 28 (shown in FIG. 1). Transaction data 540 is associated with a plurality of transaction occurring within a period of time (e.g., one month, six months, two years, etc.). Transaction data 540 is further associated with a plurality of merchants within a geographic region containing a plurality of sectors. Other information including census data or other public information 542 data may be received from external systems such as external server 504.

Merchant analytics computing device 112 also includes system resources such as a dedicated memory 554 configured for specialized usage in connection with data storage and real-time retrieval, and display of graphical representations corresponding to such stored data. For example, to realize instantaneous changing of zoom levels (e.g., refreshing the map when a user selects to zoom in or out), including any changes in the associated coloring/shading and/or selection by the user of desired analytics (e.g., size, growth, traffic, stability, etc.), dedicated memory 554 may store combinations of sector data and corresponding metrics data at different memory segments, and use unique IDs assigned to the metrics data and/or sector data for data identification purposes. The unique IDs and dedicated nature of dedicated memory 554 help ensure that the retrieval, loading, and/or rendering of the requested sector (zoom level) and/or metrics data associated therewith is efficient and does not compete with or get slowed down by other system tasks, resulting in smooth and uninterrupted performance, even during rapid zooming. From the user experience side, the user experiences a smoother UI as a result of the backend resource and data management techniques described herein. Moreover, these maneuvers may be accomplished in part via use of a user profile and information stored within the user profile, as described herein.

Dedicated memory 554 may include one or more memories, and/or may be partitioned such that a dedicated memory space is used to store data in a manner that correlates with the frequency with which the user tends to select the data. In some embodiments, dedicated memory 554 is cache memory located on or immediately adjacent a core of a processor such as processor 305. For example, dedicated memory 554 may be implemented as L1 Cache, L2 Cache, and/or L3 Cache of processor 305. Moreover, the sector data and metrics data may be stored in the appropriate cache to optimize data retrieval/loading/rendering based on usage trends of the user. In one embodiment, a user profile may be created for a user, where the user profile includes the sector data and metrics data most frequently accessed by the user. Moreover, the most frequently requested/selected sector data and metrics data may be set as a default view for the user for each subsequent use by the user of the merchant analytics computing device 112. For example, based on usage data, it may be determined that the user most frequently requests/views the county sector level with stability metrics data applied. Accordingly, the county sector level with stability metrics data applied may be set as a default view for the user. In this example, because the default view will be accessed frequently, data corresponding to the default view (e.g., data corresponding to the county sector and the stability metrics) may be stored in L1 cache to be most readily accessible (e.g., compared to if the data were instead stored in L2 or L3 cache and/or other system memory of merchant analytics computing device 112 such as other RAM of merchant analytics computing device 112 that is less readily accessible compared to the L1 cache). Similarly, usage information regarding data that is requested/viewed less frequently may be stored in the user profile and such data may be stored in a cache location such as L3 cache that is not as readily accessible as L1 cache.

As described in more detail herein, merchant analytics computing device 112 may include various tools that track a frequency with which a user requests certain data and/or are configured to learn over time and/or predict which data will be more likely to be requested by a given user (e.g., data retrieval customized to the user), and may store that data in a cache location best corresponding to the frequency with which the data is requested. For example, for a subsequent interaction of the user with the user interface (UI), when the map is first loaded, sector and metrics data from the L1 cache may be loaded based upon a prediction that the user will want to start at the zoom level and view the metrics that they most frequently tend to view. Other less frequently viewed sectors and/or metrics may be stored in other portions of dedicated memory 554 or other memories.

In one embodiment, for organizational and data retrieval purposes, the various sector zoom quantities are assigned different levels and corresponding identifiers (IDs) that may also correspond to merchants located within the particular sector level view. For example, a Level 1 designation may reflect a country-level zoom, and there may be a known quantity of merchants in the country-level zoom, each assigned a unique country-level ID that associates each merchant with the particular zoom level. There may be a plurality of additional sector zoom levels such as Level 2 (e.g., state) designation, Level 3 (e.g., city/county) designation, Level 4 (e.g., town/neighborhood) designation, and Level 5 (e.g., street) designation, for example, each with their own set of IDs. That is, at Level 2, certain merchants that would have been listed/shown in the Level 1 (e.g., country) view are no longer viewable because the zoom level has been changed to a state level. Accordingly, only merchants for the particular state will be listed, and each state-level merchant may be assigned a unique state-level ID. Likewise, at Level 3, certain merchants that would have been listed/shown in the Level 2 (e.g., state) view are no longer viewable because the zoom level has been changed to a city/county level. Accordingly, only merchants for the particular city/county will be listed, and each city/county-level merchant may be assigned a unique city/county-level ID, and so on and so forth for Level 4, Level 5, etc. When a user zooms into/out of the various sector levels, only the IDs corresponding to that sector level may be utilized to retrieve the corresponding data associated with the IDs. In doing so, only the data necessary for the display in the particular sector need be accessed, saving system resources and reducing latency. This means that if a user starts at Level 1 and zooms to Level 4, the data for intermediate Levels 2 and 3 is not accessed or loaded, and a data retrieval procedure is only performed for Level 4 data, thereby improving speed and efficiency. The ID-based organizational techniques described herein contribute to this feature.

The unique IDs may be an alphanumeric string of characters or similar, for example. By using such a unique ID-based organization system that associates sector level views with the merchants present in such sectors, the IDs can be stored in a data structure such as a table for efficient and fast retrieval. The ID-based organizational system can be implemented for any data of the various sectors, metrics, merchants, etc. Moreover, when this ID-based organizational system is paired with the other optimization techniques described herein, tangible gains in processing, data storage/retrieval, and graphical display of such data are realized. For example, an ID may include 16 total characters, where certain characters of the ID are user to represent certain data. For example, various characters of the 16 character ID may be assigned to different aspects of the data that the ID is formatted to represent. In one example, a 4 character leading string of the overall 16 character string may represent sector data, whereas the next 4 character string may represent metrics data. The remaining 8 characters of the total 16 characters of the ID may then relate to other information, such as which merchants are viewable within a certain sector view, more nuanced merchant data (e.g., type of merchant, etc.) as well as other information relating to associated coloring/shading for the map. For example, for the 4 character leading string, the first 2 characters may be “00” indicating sector data, and the last 2 characters of the 4 character leading string may range from “01” to “50” to represent the 50 states of the USA, such as in alphabetical order. Thus, a leading string of “0001” may represent the state of Alabama, whereas a leading string of “0033” may represent the state of North Carolina. Accordingly, the ID may contain specific subsets of characters that identify certain types of data, and each designated subset of characters may be a unique identifier of the associated data itself, within the overall full unique ID. For example, within a 16 character ID, certain subsets of characters may function as a unique ID of metrics data, merchant data, sector data, and/or other relevant data, while at the same time the overall 16 character ID functions as a unique identifier. These characters may be read/parsed by merchant analytics computing device 112 to extract and determine the corresponding information and cause downstream retrieval/fetching, loading or pre-loading of corresponding data to occur. This is just one example of how an ID can be formatted, and other formats are contemplated by this disclosure.

In one example use case, when a user zooms in on a specific sector, merchant analytics computing device 112 refers to the corresponding table ID entries to both identify the data corresponding to the selected sector as well as the metrics and/or other merchant data for the sector. Yet further, data corresponding to the level of zoom that corresponds to the detected physical input by the user (e.g., a user's fingers pinching on a touch screen or scrolling via a mouse click wheel) may be correlated to a particular sector. For example, a fast or wide pinch may correlate to a large jump between sectors (e.g., from Level 1 to Level 5) whereas a smaller pinch motion may be correlated to a smaller jump between sectors (e.g., from Level 1 to Level 2). Retrieval from dedicated memory 554 is then configured to only load the data for the sector corresponding to the detected level of zoom based on the user input.

As another example, when a user zooms from the country level to the state level to view merchants in the state of North Carolina, for example, the zooming may be recognized and cause a lookup to be performed corresponding to merchant data in North Carolina at the state level. Put another way, a corresponding ID for this zoom scenario may associate the zoom level with the sector which is also associated with the corresponding merchant data. Moreover, data corresponding to other zoom levels may be handled in a variety of manners. For example, since the user zoomed from the country view to the state view, data corresponding to any view above the state level, such as the country data, may be unloaded or otherwise not be fetched since it is assumed/learned that the user is not interested in data above the state level. Data corresponding to views below state level, such as street level, may be pre-fetched since it may be assumed/learned that the used will want to drill down from the state level to more granular data, such as at the street level. Alternatively, data corresponding only to the recognized zoom level may be fetched/loaded, such as only the state level data in this example. The state level data may be stored in a cache memory for quick and efficient retrieval and loading of the state level data as described herein.

To further enhance performance, additional mechanisms and techniques such as utilizing data overlap and other caching mechanisms may be employed. For example, adjacent sector levels may share some overlapping data to ensure smooth transitions when zooming in and out and/or panning across sector levels. Thus, there may be some caching of data between Levels 1 and 2, but there may not be caching between Levels 1 and 5 because it is not likely that there will be much overlap between the data of Levels 1 and 5 due to the different levels of granularity associated with each level. As described herein, frequently accessed data may be cached in a memory that is most readily accessible (e.g., a fastest portion of dedicated memory 554), and/or other buffering techniques may be implemented to reduce the need for repeated data retrieval. Yet further, parallel processing and/or asynchronous loading techniques may be utilized to fetch and render data in the background without interrupting the user experience. As the user zooms in and out, relevant graphics and corresponding data are loaded and displayed in real-time, while the non-relevant graphics and corresponding data may be unloaded to free up space in a designated memory portion. For example, if a user zooms from Level 1 to Level 5 and then to Level 3, the Level 5 data may be unloaded once the zoom to Level 3 is detected. Moreover, as described herein, the various sector level data may be stored in memories with faster retrieval times to further aid in smooth transitions between levels and faster loading times when zooming in and out. The ID-based organizational system helps to enable such dynamic zooming and refreshing of the corresponding graphical representations shown as part of the map.

In some embodiments, dedicated memory 554 is a graphics processing unit (GPU) that may include Video Random Access Memory (VRAM) that has a high data transfer rate for quickly reading and writing large amounts of data. Parallel processing may be realized by the VRAM being configured to work in tandem with the GPU, to process many data threads simultaneously, as described herein.

Merchant analytics computing device 112 includes a plurality of modules 560, 570, 580, 582, and 584 that facilitate generation and display of merchant analytics. Specifically, merchant analytics computing device 112 includes sector definition module 560 configured to define sectors and identify merchants located in each sector, as specified in the Sector Definition Phase. Sector definition module 560 may specifically identify one sector of a plurality of sectors within a geographic area in which each merchant associated with transaction data 540 (i.e., identified in transaction data 540) is located. Sector definition module 560 may update merchant records 552 to reflect the sector in which each associated merchant is located.

Merchant analytics computing device 112 also includes merchant analysis module 570 configured to generate analytics for each merchant record 552 (or for each sector in which a merchant is located) in merchant management portfolio record 550, as specified in the Evaluation Phase.

In the example embodiment, merchant analysis module 570 is configured to generate aggregated merchant analytics for each sector based on transaction data 540 associated with all merchants of the plurality of merchants located in that particular sector. The aggregated merchant analytics represent a ranking of each sector relative to all other sectors of the plurality of sectors. Merchant analysis module 570 is also configured to determine (e.g., using merchant definitions 510) a total pending loan amount for a subset of the plurality of sectors, each sector in the subset of sectors having at least a predetermined number of merchants having loans issued thereto. For instance, each sector may have at least five merchants having loans issued thereto. Merchant analysis module 570 is further configured to calculate a loan risk score for each sector of the subset of sectors based upon the aggregated merchant analytics and the total pending loan amount for each sector.

In certain embodiments, merchant analysis module 570 is configured to calculate a loan risk score based upon another calculated score. For example, merchant analysis module 570 may calculate a growth of each sector using received transaction data for a subset of the plurality of merchants located in each corresponding sector, wherein the growth represents a difference in total sales revenue in each sector from a beginning of the period of time to an end of the period of time, determine a relative ranking for each sector by comparing the growth of each sector of the plurality of sectors, and generate a growth score for each sector based on the relative ranking. In some such examples, calculating the loan risk score for each sector may include multiplying the total pending loan amount for a sector by a normalization of the growth score for the sector and dividing by an average pending loan amount for the subset of sectors. Merchant analysis module 570 may perform similar steps for calculating a loan risk score based upon stability, size, traffic, ticket size, and/or composite score(s).

In some embodiments, merchant analysis module 570 also identifies, for each merchant of the plurality of merchants, one merchant industry with which the merchant is associated. Merchant analysis module 570 generates aggregated industry analytics for each merchant industry based on the transaction data associated with all merchants of the plurality of merchants associated with the merchant industry within each sector (e.g., all restaurant merchants within a sector). Broadly, the aggregated industry analytics represent a ranking of each industry within the sector relative to each industry within one or more other sectors. Merchant analysis module 570 also further calculates the loan risk score for each sector of the subset of sectors based upon the aggregated industry analytics. Such an “industry loan risk score” within each sector (or for a plurality of sectors) may provide additional insight for the user. For instance, although an “overall” loan risk score for a sector may indicate a relatively high risk for providing a loan, an industry loan risk score for a manufacturing industry or a service industry may indicate relatively lower risk.

In some embodiments, merchant analysis module 570 also determines a loan risk score trend for at least one sector based upon calculated loan risk scores for the at least one sector for two or more periods of time. The loan risk score trend may be displayed on the user interface of user computing device 502, for instance, graphically displayed in association with the merchant loan portfolio (e.g., as color-coding and/or display with respect to a map).

Merchant analytics computing device 112 also includes optimization module 580 configured to perform optimization tasks for merchant management portfolio record 550 as specified in Optimization Phase.

Merchant analytics computing device 112 also includes display module 582 configured to perform display tasks in connection with the UI. For example, dedicated memory 554 and display module 582 may be integrated or otherwise operatively connected and/or in communication with each other in such a manner to optimize the display of data, such as when a user changes sectors and/or metrics, the UI may be refreshed accordingly. For example, display module 582 is programmed to key off of the IDs to reap improvements in display speed. That is, display module 582 may recognize that a certain string of the ID relates to a certain sector, and be able to prepare for such a sector to be loaded before or simultaneous with the loading of the data for such sector. In doing so, the display module 582 can effectively pre-load certain aspects of the UI, resulting in a smoother user experience. Display module 582 may further be utilized in conjunction with an AI/ML module 584 as described herein.

In some embodiments, display module 582 is configured as a software module, or, in other embodiments, as a combination of software and hardware. For example, display module 582 may operate in conjunction with a dedicated processor specialized for display processing tasks (e.g., rendering, etc.). Additionally, in some embodiments, graphical data associated with display module 582, such as data for zooming in and out of sector levels, may be stored in memories such as memory 556 and/or 558 to take advantage of the benefits described herein. Such graphical data may be included within sector data or isolated from but still associated with the sector data.

Merchant analytics computing device 112 also includes AI/ML module 584 configured to perform artificial intelligence and/or machine learning tasks. For example, AI/ML module 584 is implemented to train and deploy one or more AI/ML models 586, where model 586 may be trained on historical user selection data for a given user obtained over time, where the selection data represents the data that is requested/viewed by users. In some embodiments, the historical user selection data includes historical sectors and metrics requested for viewing by individual users that is used to generate user-specific models and/or global models. For example, model 586 may learn the user's most frequently selected types of metrics and sectors, and data corresponding to such may be stored in system memories such as dedicated memory 554 that provide for faster retrieval of such frequently used data. As described herein, AI/ML module 584 and model 586 may additionally or alternatively be implemented to detect patterns for a variety of operational aspects, including patterns relating to data storage and retrieval, processing tasks, including learning which tasks are more process intensive than others, and how to make changes to better improve performance of merchant analytics computing device 112. This may include model 586 learning how to alter processor clock speeds and other system adjustments to optimize data processing, rendering of the map and any associated graphics, and so on and so forth.

Put another way, model 586 may, over time, learn both usage patterns of users as well as how to adjust system settings and system resources to optimize the storage, retrieval, processing, and display of data associated with a user's usage patterns, including selection data such as the metrics (e.g., growth, stability, etc.) that a user most frequently requests (e.g., views) at the sector level (e.g., state, block) that the user most frequently requests (e.g., views). Further, model 586 may learn how to best store, retrieve, process, and display data of the metrics and sector levels that a user views less frequently. In operation, an output from model 586 may include one or more instructions such as system instructions for merchant analytics computing device 112 to shift data between various memories to make certain data more or less readily accessible, or locate certain data within portion of a single memory, as well as adjusting processor clock speeds, etc. for a given task. For example, model 586 may learn to increase a processor speed of processor 305 in association with when a user changes a zoom level from a country level view to a street level. That is, since there may be minimal overlap between the data presented in the country view compared to the data of the street view, the adjustment to a higher clock speed may improve the speed with which the graphical transitions from country to street level occur in connection with the zoom level change. In some embodiments, AI/ML module 584 is configured as a software module, or, in other embodiments, as a combination of software and hardware. For example, AI/ML module 584 may operate in conjunction with a dedicated processor that is specialized for AI applications.

Merchant analytics computing device 112 is also configured to provide outputs 590 as described herein. Specifically, outputs 590 may include merchant analytics for each merchant for which there is an associated merchant record 552, as well as aggregated merchant analytics for each associated sector. Outputs 590 may also include an optimized portfolio record 550, which may be sorted to identify and emphasize merchants that align with investment goals. Outputs 590 may also include any and all formatted output for display on a user interface of a user computing device 502 (e.g., client system 114, as shown in FIG. 2). Specifically, merchant analytics computing device 112 provides outputs 590 to facilitate displaying, on a user interface of user computing device 502, the loan risk score for each sector of the subset of sectors, wherein the loan risk score is graphically displayed in association with a merchant loan portfolio.

FIG. 5B is a simplified data flow diagram for organizing aggregated merchant analytics including metrics and sectors used in connection with the UI provided by merchant analytics computing device 112. Processing the significant amounts of merchant data, including applying various gradations of color (e.g., lighter red vs. darker red) and/or shading when shifting between different sector views as described herein, is process intensive and includes associated technical challenges. In order to have a streamlined, smooth-operating UI on the front-facing (e.g., user-facing) side, the backend processing should be designed and optimized for the particularized tasks associated with the handling of data as described herein. For example, when a user makes a selection 592 such as choosing or switching between different metrics and/or different sectors, and/or requesting certain data to be displayed, the UI will both “zoom in”/“zoom out” and “re-paint” (e.g., re-color or re-shade) the displayed sectors according to selection 592 where the user request display of certain sectors/metrics. To ensure that the user experiences a smooth UI with minimal buffering and/or other loading delays, smart data management using the techniques described herein is needed.

In this regard, in one embodiment, dedicated memory 554 includes a plurality of cache memories 556 and 558. Cache memory 556 includes an L1 cache memory, and cache memory 558 includes an L2 or L3 cache memory. Memories 556 and 558 store data corresponding to the various sector views (e.g., 602, 702, etc.) and/or metrics (e.g., 624, 724, etc.). For example, while a database such as database 120 or other storage such as storage device 134 may be utilized as a central repository for storing all of the sector and metrics data, memories 556 and 558 may be utilized to only store certain selected sector and metrics data. That is, in the case where storage device 134 is used to store all relevant data, only certain subsets of data from storage device 134 may be stored in memories 556 and 558.

Fast retrieval of a user's most frequently viewed metrics and/or sector data may be prioritized to ensure a smooth user experience when navigating the UI and zooming to view different sectors and/or the various metrics. “Fast retrieval,” or “fast,” as used herein may refer to the relative speed with which data is able to be retrieved from the various memories of or associated with merchant analytics computing device 112, where data stored in an L1 cache may generally be able to be retrieved faster than data stored in a database.

Over time, usage patterns of a user may be learned. In one example, it may be learned that a given user most frequently views, in order, state level sectors, followed by county level sectors, then block level sectors, and lastly neighborhood level sectors, as reflected in the order shown in memory 556 in FIG. 5B. This may be determined, for example, by counting the frequency with which the unique IDs corresponding to such data are accessed. Similarly, it may be learned that the same user most frequently views, in order, size metric data, followed by growth metric data, then traffic metric data, and lastly stability metric data, as reflected in the order shown in memory 558 in FIG. 5B. In this example, memory 556 is L1 cache memory and is utilized to store sector data such as state sector data 557a, county sector data 557b, block sector data 557c, and neighborhood sector data 557d, without limitation. That is, while storage device 134 may store all sector level data, from country level down to street level, as well as each intermediate level (e.g., state . . . county . . . block . . . , etc.), memory 556 only stores a subset of sector level data. In this same example, memory 558 is L2 cache memory and is utilized to store metrics data such as size data 559a, growth data 559b, traffic data 559c, and stability data 559d. That is, while storage device 134 may store all metrics data, memory 558 only stores a subset of metrics data. This is just one example of how a hierarchical data retrieval system may be accomplished by storing certain types of data in certain types of memory to optimize data retrieval times and realizing the corresponding benefits (e.g., reduced latency in data retrieval, etc.) derived therefrom in connection with providing the user interface. Additionally, while FIG. 5B only shows two examples of memory (e.g., memory 556 and memory 558), this is not limiting. For example, some embodiments may include at least three memories (e.g., L1, L2, and L3 cache memory). These cache memories may be memories located on or in close proximity to a processor such as processor 305. In some embodiments, storage 134 may include database 120 or vice versa, or storage device 134 may be a part of database 120 and vice versa.

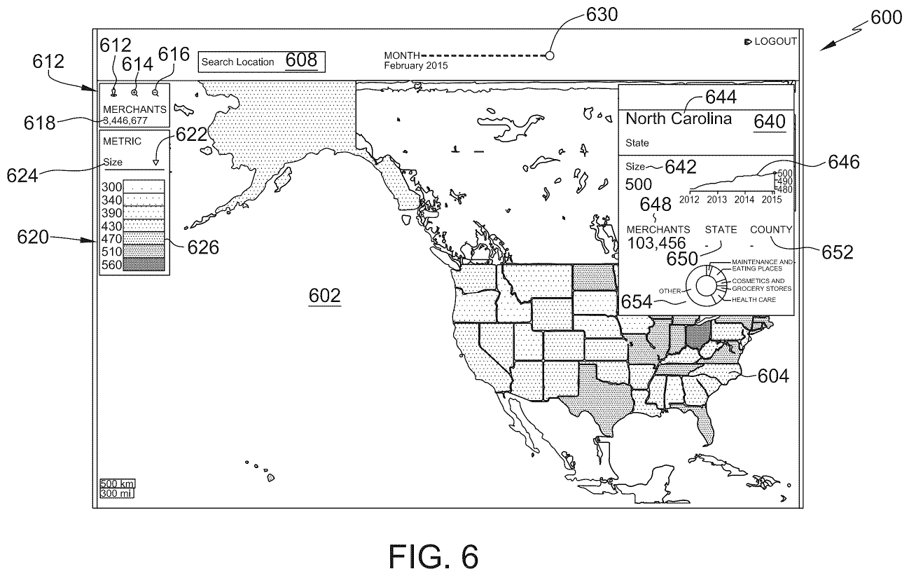

Other embodiments that prioritize fast retrieval of other data are contemplated herein. For example, instead of each of memory 556 and 558 being utilized to store the same type of data (e.g., sector data stored in memory 556 and metrics data stored in memory 558), a mix/combination of data may be stored in each memory 556 and 558. Put another way, in the case where memory 556 is L1 cache memory and memory 558 is L2 or L3 cache memory, memory 556 may be utilized to store frequently accessed data that would benefit most from fast retrieval, regardless of if the data is sector data or metrics data. Memory 558, as slower L2 or L3 cache memory, would then be utilized to store data of lesser retrieval priority. Graphical representations corresponding to the combination of data may include maps, tables, etc. as shown in FIGS. 6-15. Moreover, data corresponding to implementing the graphical representations corresponding to the combination of data may also be stored in the faster memories of merchant analytics computing device 112. For example, as described herein, data corresponding to zooming in and out of sectors may be stored in one or more of the faster memories to realize improvements in the UI with respect to zooming in and out of sectors (e.g., smoother transitions, faster refreshing/loading, etc.).

In embodiments that utilize multi-core and/or parallel processing, memory 556 may be memory that is associated with a first processor (e.g., processor 305) or a first processor core and memory 558 may be memory that is associated with a second processor (e.g., another processor 305) or a second processor core. In these embodiments, each of memory 556 and memory 558 may be L1 cache memory, associated with a respective processor or processor core. A configuration using one or more L1 cache memories may help to ensure that the data stored in each memory 556 and 558 has the fastest possible retrieval time, compared, for example, to data retrieval from other memories of merchant analytics computing device 112 such as slower L2 or L3 cache memory or even slower memory such as other RAM or storage devices of merchant analytics computing device 112.

Additionally, in some embodiments, model 586 is utilized in conjunction with display module 582 to optimize the display of graphics of UI. For example, model 586 may monitor operational parameters of system memories (e.g., memory 556, memory 558, etc.) and system processors (e.g., processor 305) and learn how to adjust usage and/or operation of such memories and processors on a need-based manner, in real-time. This may include, for example, model 586 learning that visual transitions between certain sector views are process intensive. Model 586 may be configured to recognize when such process intensive events occur, and issue instructions to cause dynamics adjustments in the operation of system components such as processor 305, such as increasing a clock speed of processor 305. Additionally, or alternatively, model 586 may issues instructions for parallel processing techniques to share loads for processing intensive tasks. As such, model 586 not only learns user behaviors and other trends and patterns and manages optimization of memory as described herein (including how some other users may have accessed data in the past; in other words, historical accessing of data by the user or by other similar users), but also optimizes system resources such as processing by various processors based on detected needs for processing intensive tasks associated with the display of the UI.

In one embodiment, the determination of which data is most (or least) frequently viewed by a user is based on a frequency threshold analysis using a threshold value relating, for example, to a frequency with which each type of metrics and sector data are viewed by a user. These thresholds may generally be referred to as request thresholds. In the case of sector data, the threshold may be referred to a sector request threshold, and in the case of metrics data, the threshold may be referred to as a metrics request threshold. For example, for a sample size of 100 prior uses the UI by a user, the user may have requested/viewed state level data 50 times and country level data only 2 times, with other sectors (e.g., county, block, etc.) filling out the other 48 views. Similarly, for the 100 samples, the user may have requested/viewed size metrics data 65 times and stability data only 5 times, with other metrics (e.g., growth, traffic, etc.) filling out the other 30 views. A threshold value system and/or scale may be implemented to weigh or otherwise rank the most and least frequently viewed data including any intermediate usage in between most and least viewed, which may then be loaded into a user profile of a user as described herein. If requests/views of a given metric exceed a metric request threshold, that metric may be ranked such that it is stored in a more readily accessible (e.g., “faster”) cache memory, whereas views of a metric that are below the metric request threshold may be stored in a less readily accessible (e.g., “slower”) memory. Similarly, if requests/views of a given sector exceed a sector request threshold, that sector may be ranked such that it is stored in a faster cache memory, whereas requests/views of a metric that are below the sector request threshold may be stored in a less readily accessible (e.g., slower) memory. This is just one example of a hierarchical data organization scheme, and other schemes are contemplated by this disclosure.

Further regarding FIG. 5B, in one embodiment, data 557a-557d and data 559a-559d are stored in a data structure such as a table 594 within a system memory such as, but not limited to, storage device 134. In some embodiments, table 594 may be configured as a lookup table capable of being queried and generating query results and include a plurality of fields for organizing data. Table 594 may be used to pre-store certain data such as IDs as described herein to realize improved retrieval of sector, metrics, and/or merchant data when a user switches sectors, as described herein. In one embodiment, the plurality of fields of table 594 includes fields such as a Sector ID field, a Sector Name field, a Metrics ID field (e.g., IDs representing the various merchant business characteristics of growth, stability, size, traffic, and ticket size), a Metrics name field, a Merchant ID field, a Merchant Name field, and other fields and/or corresponding IDs. The fields of table 594 also include a timestamp field for recording a date/time when the data in each field was accessed. In doing so, a frequency with which the various types of data, IDs, etc. are queried can be determined and utilized in connection with determining how to optimize the storage of the most and least requested types of data that a particular user accesses, in the system memory best corresponding to the user's usage patterns, as described herein.

A user profile 596 may be generated for a given user. User profile 596 may be stored, for example, in a memory such as database 120, storage device 134, etc. In one embodiment, data corresponding to user profile 596 is stored in table 594, including IDs such as IDs 598a-598c shown in FIG. 5B. IDs 598a-598c may, for example, represent the IDs of merchants present in the sector view that the user most frequently requests/views, or may represent IDs of other data that the user often requests. IDs 598a-598c thus provide a mechanism to pre-store and then retrieve relevant data for a given user. IDs 598a-598c are merely a few examples of the IDs described herein and can range up to n IDs (e.g., 598n) for any given fields of one or more tables such as table 594. For example, as described herein, a unique ID may be used for each sector level. That is, for a state-level sector, the growth metric may be assigned one ID, whereas in a street-level sector the growth metric may be assigned a different ID. However, the two different IDs may still share some commonality so that the merchant analytics computing device 112 can rapidly retrieve and display the requested data. In one example of the same (e.g., growth) metric being viewed at two different sector levels, the ID may be formatted in part as [METRICS CODE]-[SECTOR CODE], where the [METRICS CODE] portion would be the same since the same growth metric is being viewed, but at different sector levels. For example, for illustration purposes only, the [METRICS CODE] for the growth metric may be coded as [0101], whereas the sector code for the state level may be coded as [5050] and the sector code for city level may be coded as [6060]. Thus, the portion of the ID representing the growth metric at the state sector level is [0101]-[5050], and the portion of the ID representing the growth metric at city sector level is [0101]-[6060]. The commonality of the [0101] portion allows for quick sorting of the growth metric following by quick sorting of the applicable/available sectors, such as when the IDs are stored within fields of a table such as table 594. When such IDs are utilized in conjunction with the other system resources management techniques and/or AI-based techniques described herein, improvements in the display of user-requested data are realized. Additionally, part of the string of the ID may be utilized to designate associated memory portions to reap further gains in data storage/retrieval. For example, a portion of the string of an ID may reflect the last known storage location.

Table 594 thus realizes improvements in at least: (i) efficiency, by enabling quick lookup of metrics of the merchant analytics and sector data, (ii) flexibility and ease of querying, by using, for example, a “universal” data format such as JSON in conjunction with an ID-based system as described herein, and (iii) scalability, in that additional fields can be added as more analytics are introduced, such as merchant loyalty program details or seasonal trends, or if analytics are removed (e.g., in cases where certain analytics have been determined to lack beneficial analytical value). In some embodiments, table 594 is configured as a dynamic hierarchical lookup table designed to efficiently store, retrieve, and dynamically prioritize data based, for example, on query frequency. Table 594 may operate as a hybrid of a standard lookup table and a priority queue, enhanced by AI-driven adaptability. Table 594 is designed to scale with increasing data volume while maintaining consistent performance. For large datasets, table 594 may incorporate partitioning or sharding to distribute data across multiple nodes, allowing for parallelized access.

Some additional functions of table 594 include (i) mapping keys to values for fast and efficient data retrieval, such as by way of the IDs as described herein, (ii) query operations (e.g., for hash tables or for tree-based implementations) optimized for minimal latency, (iii) hierarchical/prioritized storage: data entries within table 594 are organized into tiers or levels based on priority, where the prioritization reflects the frequency or importance of the queries associated with each key (e.g., frequently queried data is stored at higher priority levels, and less commonly queried data is placed at lower levels), (iv) dynamic adaptation: table 594 employs a feedback mechanism powered by AI to analyze query patterns in real-time, where over time, entries with increasing query frequency are dynamically reordered (e.g., promoted) to higher-priority levels, while less-used entries are also dynamically reordered (e.g., demoted), ensuring that frequently queried data is always more readily accessible. While table 594 is shown in FIG. 5B as being stored within storage device 134, table 594 may be stored in other memories, including database 120 and memory 554, for example.

As described herein, when using “universal” formats such as JSON that integrate well with databases, application programming interfaces (APIs), and AI frameworks, models such as ML models can directly process JSON-formatted data for training and inference (e.g., detecting patterns in data). JSON's hierarchical and flexible structure make it well-suited for data structuring and versatility in connection with storing varied and detailed datasets. AI/ML module 584 can then easily parse the nested fields and arrays in JSON to analyze contextual relationships between data points, where AI/ML module 584 can extract patterns from the structured data without requiring extensive preprocessing. Additionally, JSON's machine-readability makes for streamlined ingestion via AI model 586, where JSON files, etc. can be parsed efficiently, saving computational resources. Yet further, in the case where the fields of table 594 include timestamp fields, AI/ML module 584 can train on such data and detect trends or anomalies for the reasons and/or usages described herein. Yet further still, JSON can be used in real-time data streams to feed AI model 586 for real-time analysis. For example, live user interactions can be continuously captured in JSON format and passed to AI/ML module 584 and/or model 586 for immediate pattern detection and downstream adjustments to data storage locations, processor operational parameters, etc.

AI integration with table 594 may include AI/ML module 584 continuously monitoring access patterns and updating the hierarchical structure without requiring manual intervention. Techniques such as reinforcement learning or statistical analysis are used to predict and adapt to future query trends. AI/ML module 584 may also implement policies such as stale data or “aging” policies which gradually reduces the priority of stale entries over time. As such, not only is a universal format such as JSON beneficial with respect to communication between systems and APIs, but JSON is also amenable for usage with an AI tool. In addition to JSON, or as an alternative to JSON, other universal formats such as XML may be implemented.

In one example implementation, as users repeatedly select certain data (e.g., metrics data such as size, growth, etc.) and/or sectors (e.g., state, block, etc.), the corresponding entries in table 594 are prioritized to correspond with a frequency with which the data is selected by a user. Over time, AI/ML module 584 optimizes various operational aspects to return results faster for popular/frequent queries, ensuring both speed and relevance. Such as dynamic hierarchical lookup table configuration offers a robust solution for handling high query volumes, adapting seamlessly to changing usage patterns, and maintaining optimal performance. For example, over time, it may be determined that a particular user most frequently views growth data on a block-level. Accordingly, for that particular user, dedicated memory 554 may store the growth data and the block sector data in a fastest memory of the system such as an L1 cache.

In some embodiments, model 586 may, based on learned user behavior over time, build tables such as table 594 in connection with data storage and retrieval optimizations. For example, model 586 may learn over time how to optimize the fields of a table based on a particular user's usage, and generate a new table that, compared to an existing table, is restructured for improved efficiency. This type of operation may be performed on a periodic basis. Prior redundant tables may be overwritten by such new AI-generated table, or new AI-generated tables may be stored in addition to existing tables. Moreover, revising and/or building tables 594 via model 586 is able to be achieved in real-time. Model 586 may also be trained based on historical user requests/selections to recognize and/or generate user profiles 596.

FIG. 5C is a data flow diagram for displaying sectors and analytics on a user interface using merchant analytics computing device 112. More specifically, FIG. 5C illustrates AI-assisted display of sectors and metrics of the merchant analytics. As described herein, one or more models 586 may learn over time the specific data that a particular user most frequently views and/or may learn other user-specific patterns and trends. To implement this learned usage data as both a technical improvement to the operation of merchant analytics computing device 112 and a practical improvement to the user experience, an output from model(s) 586 includes an instruction to re-prioritize which type of data is stored in which type of memory. For example, compared to memory 556 as shown in FIG. 5B (also shown in the top half of FIG. 5C), memory 556 shown in the lower half of FIG. 5C stores data in an order which model 586 has determined the data is most likely to be accessed, such as county data 557b, size data 559a, block data 557c, and growth data 559b. Similarly, compared to memory 558 shown in FIG. 5B (also shown in the top half of FIG. 5C), memory 558 shown in the lower half of FIG. 5C stores data in an order that model 586 has determined is of lesser retrieval priority than the data in memory 556. The arrow shown in connection with AI/ML module 584 in FIG. 5C represents an organization/reorganization function of model 586 relative to data within memories 556 and 558, where AI/ML module 584, by way of model 586, causes memory 556 to store a combination of most frequently viewed sector and/or metrics data that have been determined to exceed a request threshold. Similarly, AI/ML module 584, by way of model 586, causes memory 558 to store another combination frequently viewed metrics and sector data, but that may not exceed the request threshold. By virtue of model 586 learning user patterns and trends, the most viewed data is stored in the memory that best suites the user's usage, where the benefits derived from these nuanced and particularized data storage techniques are realized within the user interface as improved display speeds, smoother zooming, smoother display of metric data, smoother coloring/shading display, etc. More generally, such optimizations improve the operation of merchant analytics computing device 112, such as by more efficiently allocating and/or controlling system resources. For example, the reorganized data (e.g., data 557b, 559a, 557c, 559b in memory 556 and data 557a, 559c, 557d, 559d in memory 558) as shown in the lower half of FIG. 5C is aided by the unique ID techniques described herein, where the unique IDs provide for improved retrieval of the data for memory location reorganization purposes.

While not shown in FIG. 5C, the processes performed in FIG. 5C utilize the ID-based organizational techniques described herein to aid in streamlined storage (e.g., pre-storage) of the data in memories 556 and 558. For example, by way of the ID-based organizational techniques described herein, when a user changes a zoom level from, for example, the state sector to the street sector, the IDs of merchants viewable at the street level are retrieved from memory for display via the UI, thereby reaping efficiency gains in the refreshing of the data at the street level sector view. For example, whereas 5,678 merchants might have been provided in the state level view, only 6 merchants may be provided in the street level view, and the unique street-level IDs corresponding to the 6 street-level merchants are utilized to achieve improved retrieval and display times so that the user experience is enhanced by way of the improvements made in data organization and resource (e.g., memory) management. IDs may also be utilized for other aspects such as color/shading data, etc. Put another way, any underlying data of the graphical representations shown in the UI in FIG. 6-15 may be implemented with the ID-based techniques described herein to reap the corresponding benefits.

Model 586 may include predictive aspects as well. For example, model 586 may detect that a user has recently been focusing on viewing stability data 559d, and may output an instruction to add stability data 559d to a faster memory location, which may entail moving stability data 559d from storage in L3 cache memory to storage in L1 cache memory. Likewise, model 586 may detect that a user has decreased their viewing of other data types, and cause those other data types to be relocated from an L2 cache memory to an L3 cache memory, for example, to reflect the lower priority. Memory 556 and/or 558 may be referred to as having first, second, third, etc. portions, where a first portion may be L1 cache, a second portion may be L2 cache, etc. However, a “portion” is not limited to be L1 . . . . Ln cache and may instead be used in a generic manner to describe any portion of any memory described herein. Model 586 is able to cause dynamic data shifts within memory in real-time, so that data such as metrics data, sector data, map data (e.g., coloring, shading, etc.) and any other system data that may benefit from taking advantage of faster memory can be relocated on the fly as determined by model 586.

FIGS. 6-15 are example screenshots of a user interface (e.g., user interface 118, shown in FIG. 2) of a user computing device (e.g., client system 114, also shown in FIG. 2). The example screenshots include data generated by merchant analytics computing device 112 (shown in FIG. 2) such as merchant analytics, as described herein. Merchant analytics computing device 112 communicates the merchant analytics to the user device for display on interactive user interface 118.

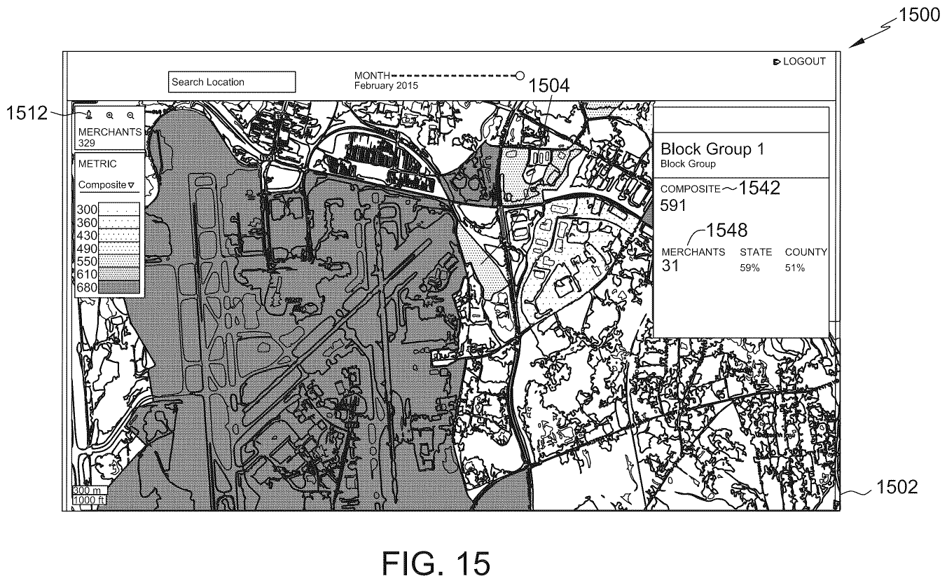

More specifically, FIG. 6 depicts a U.S.-level screenshot 600 showing a “zoomed out” view 602 of the United States of America. In view 602, the sectors are defined and displayed at a state-wide level. The screenshot 600 also includes several tools that enable a user to navigate the user interface and to examine the data generated and transmitted by merchant analytics computing device 112. For example, the screenshot 600 depicts a location search bar 608, which enables the user to search for a geographic region of interest. The screenshot 600 also includes a view navigation module 610. The view navigation module 610 includes a “view type” selectable icon 612, which enables the user to toggle between a “street map” view (as shown in view 602) and a “satellite” view (as shown in FIG. 15). The view navigation module 610 also includes “zoom out” 614 and “zoom in” 616 selectable icons. The view navigation module 610 further includes a merchant number indicator 618, which indicates the number of merchants encompassed by the current view (3,446,677 in view 602). In embodiments where anonymization is required and/or desired, a “street” level sector view may not be able to be generated if an insufficient amount of merchants is present on a given street such that anonymization is precluded (e.g., too few merchants may allow for data to be attributed to a specific merchant).

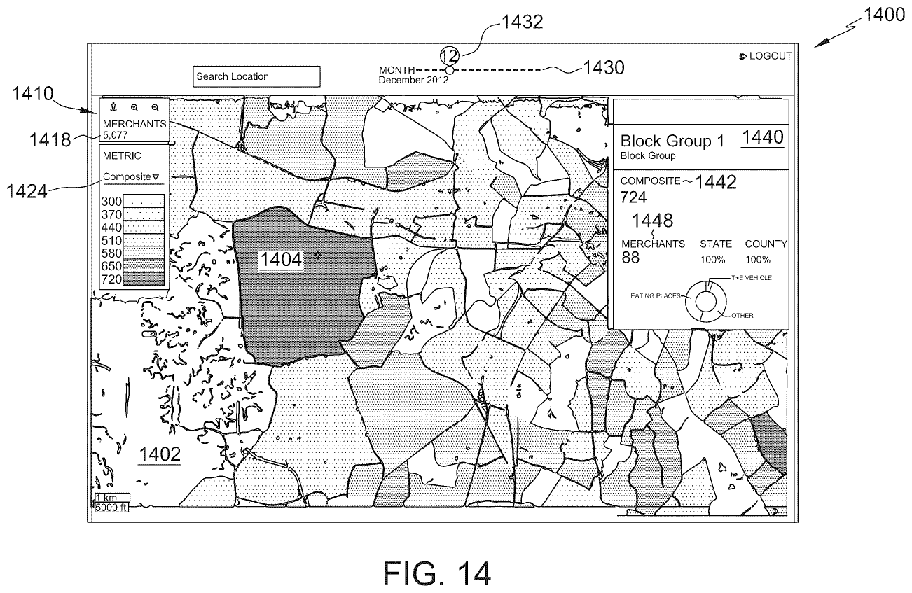

The screenshot 600 further includes a metric information module 620. The metric information module 620 allows the user to select between available merchant analytics metrics (e.g., Composite, Growth, Stability, Size, Traffic, and Ticket Size scores) using a drop-down menu 622. In the example embodiment, the metric information module 620 further includes a score scale 626, which provides an explanation to the user of the color-coding of the sectors. The sectors displayed in view 602 are shown “painted” with colors and/or shades corresponding to the score scale 626, which visually indicates the relative score (for the selected metric 624) for each sector. When a user chooses a different metric using drop-down menu 622, the user interface will “re-paint” (i.e., re-color or re-shade) the displayed sectors (and, in some cases, the score scale 626) to reflect a range of numerical scores according to the selected metric 624. In the example embodiment, a darker color indicates a higher score. In view 602, the selected metric 624 is “Size.” Accordingly, the merchant analytics provided on the user interface are size scores for selected sectors. The screenshot 600 also depicts a time-selection slider 630, which will be described further herein with respect to FIG. 14.

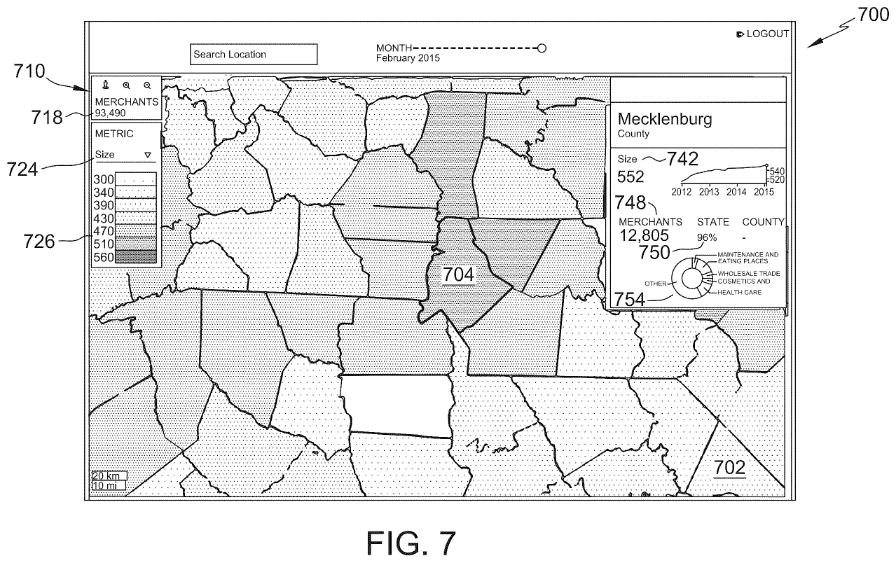

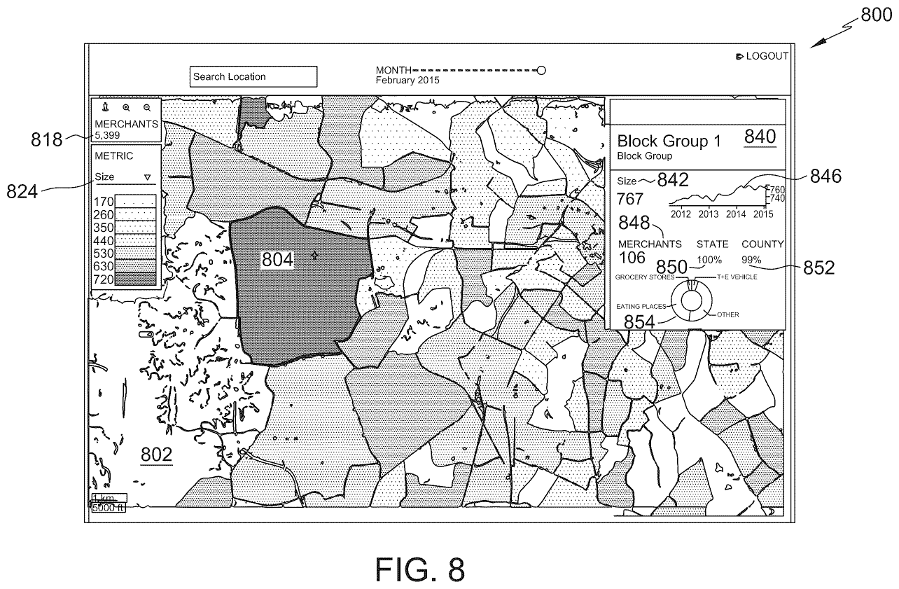

The screenshot 600 also depicts a “smart chart” 640, which provides the user with a score 642 for a selected sector 604, as well as additional information. In view 602, North Carolina is the selected sector 604, as indicated by the sector indicator 644 of the smart chart 640. The smart chart 640 includes, in view 602, a size score 642 for North Carolina (500 in view 602). As view 602 depicts sectors at a state level, the size score 642 for North Carolina is relative to all other states. The smart chart 640 also includes a trend graph 646, which is a visual representation of the size score trends for the selected sector 604 (North Carolina) over time. The smart chart 640 also includes its own merchant number indicator 648, which indicates the number of merchants included in the selected sector 604 (North Carolina). State and County ranking indicators 650, 652 in the current view 602, are blank, as they are not applicable to a state-level sector. State and County ranking indicators 650, 652 will be described further herein with respect to FIGS. 7 and 8. The smart chart 640 also includes an industry chart 654 (a pie chart in the illustrated embodiment), which indicates the percentage of merchant locations in the selected sector 604 associated with various industries.

FIG. 7 depicts a screenshot 700 showing a state-level view 702 (zoomed-in relative to view 602, shown in FIG. 6). View 702 depicts the state of North Carolina divided into county-level sectors. Notably, the merchant number indicator 718 in the view navigation module 710 has changed (relative to the merchant number indicator 618 in FIG. 6), depicting 93,490 merchants encompassed by view 702. The score scale 726 has also changed (relative to score scale 626 in FIG. 6), such that the colors or shades indicate different ranges of scores.

In view 702, Mecklenburg County is the selected sector 704. Accordingly, the information in the smart chart 740 has changed to reflect the data representing Mecklenburg County. For example, the size score 742 is 552, the merchant number indicator 748 reflects a much smaller number of merchants encompassed, and the industry chart 754 has also been updated. The state ranking indicator 750 is now populated. The state ranking indicator 750 denotes the percentile of the selected sector 704 relative to all other sectors in the state. In view 702, the state ranking indicator 750 reads 96%, denoting that Mecklenburg County is in the 96th percentile of counties in the state, according to the selected metric 724 of “size.”

FIG. 8 depicts a screenshot 800 showing a view 802 that is zoomed-in relative to view 602 and view 702 (shown in FIGS. 6 and 7, respectively). View 802 depicts a portion of Mecklenburg County at block-group-level sectors. In view 802, “Block Group 1” is the selected sector 804. Block Group 1 includes, in this example, Charlotte-Douglas Airport (CLT). Once again, the merchant number indicator 818 has decreased, and the information in the smart chart 840 has changed. The size score 842 (now 767), trend graph 846, merchant number indicator 848, state ranking indicator 850, and industry chart 854 reflect data representative of Block Group 1. Moreover, the county ranking indicator 852 is now populated. The county ranking indicator 852 denotes the percentile of the selected sector 804 relative to all sectors in the county. In view 802, the county ranking indicator 852 reads 99%, denoting that Block Group 1 is in the 99^{th} percentile of block-group-level sectors in the county, according to the selected metric 824 of “size.”

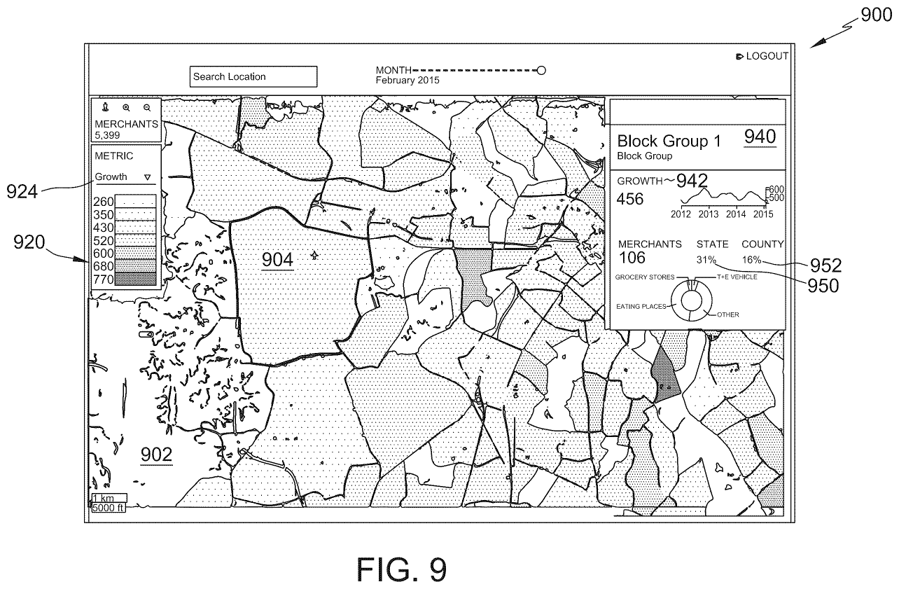

FIG. 9 depicts a screenshot 900 showing a view 902 that is the same in geographical scale as view 802 (shown in FIG. 8). However, view 902 has substantially changed in terms of the shading of the sectors. The metric information module 920 shows the selected metric 924 is the merchant analytic of “Growth,” thus the sectors have been “re-painted” or “re-shaded” to reflect the growth scores of the visible sectors. The smart chart 940 for selected sector 904 Block Group 1 shows that the growth score 942 for Block Group 1 is 456, and the state and county ranking indicators 950, 952 have substantially decreased (relative to state and county ranking indicators 850, 852 shown in FIG. 8). As Block Group 1 includes CLT, it follows that the growth score 942 would be lower than the size score 842 (shown in FIG. 8). Though airports may have very high sales revenue (size) due to the sheer number of people passing through every day, their growth may be low, as the number of people travelling (and therefore the amount of money spent at airports) may not substantially increase from year to year.

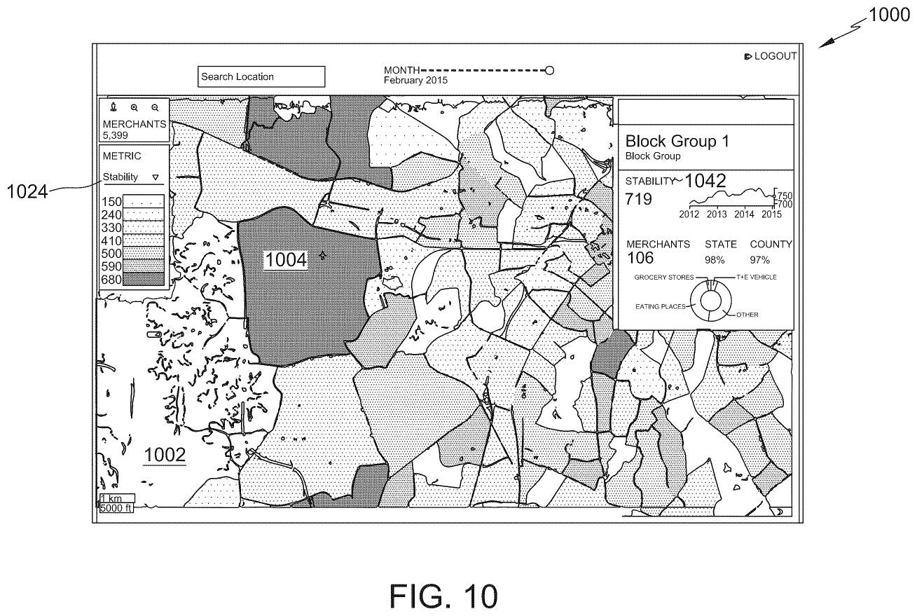

FIG. 10 depicts a screenshot 1000 showing a view 1002 that is the same in geographical scale as views 802 and 902 (shown in FIGS. 8 and 9, respectively). However, again, view 1002 shows different shading of sectors than in FIG. 8 or 9. View 1002 reflects the selected metric 1024, the merchant analytic of “Stability.” The selected sector 1004 Block Group 1 has a high stability score 1042 of 719, and also ranks highly relative to sectors in the state and county. Again, considering that Block Group 1 includes CLT, it stands to reason that sales revenue may be relatively stable, as the amount of people travelling (and therefore the amount of money spent at airports) may not substantially fluctuate from year to year.

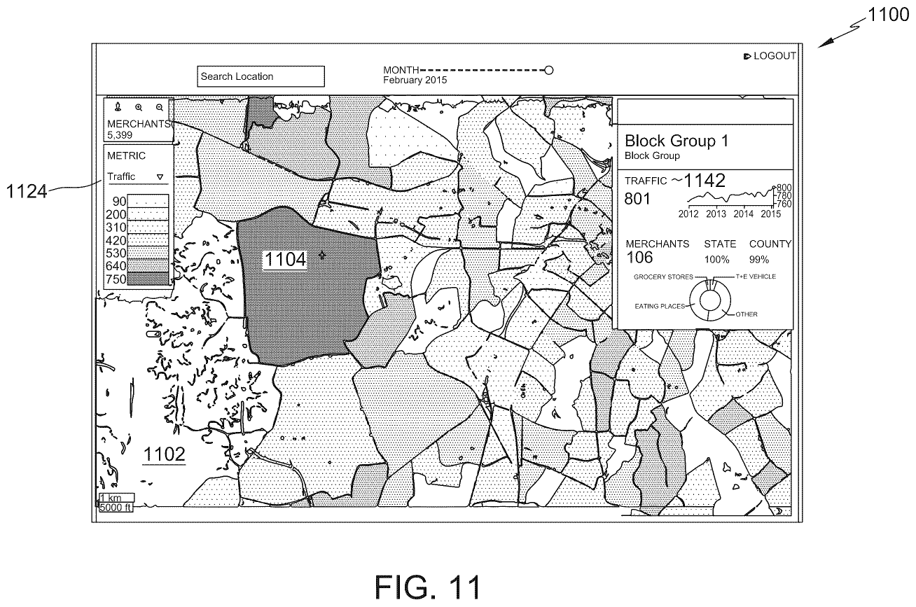

FIG. 11 depicts a screenshot 1100 showing a view 1102 that is the same in geographical scale as views 802, 902, and 1002 (shown in FIGS. 8, 9, and 10, respectively). View 1102 reflects the selected metric 1124, the merchant analytic of “Traffic.” The selected sector 1104 Block Group 1 has a very high traffic score 1142 of 801, and again ranks very highly relative to sectors in the state and county. Considering the number of people travelling through airports (such as CLT) each day, and hence each years, it follows that the transaction traffic may be very high, compared to other sectors in the same geographic region.

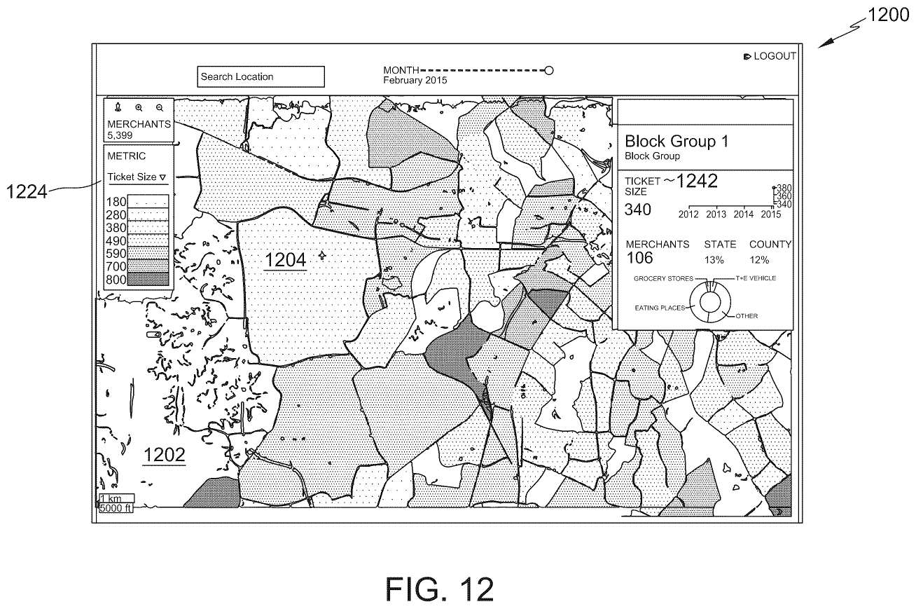

FIG. 12 depicts a screenshot 1200 showing a view 1202 that is the same in geographical scale as views 802, 902, 1002, and 1102 (shown in FIGS. 8, 9, 10, and 11, respectively). View 1202 reflects the selected metric 1224, the merchant analytic of “Ticket Size.” Selected sector 1204 Block Group 1 has a very low ticket size score 1242 of 340 and ranks low relative to sectors in the state and county, despite Block Group 1 having a high numerical size score 842 (shown in FIG. 8) and a high numerical traffic score 1142 (shown in FIG. 11). Many transactions initiated in an airport (such as CLT) may be purchases of food and beverages by travelers, which may have relatively small ticket sizes (as opposed to, say, a jewelry store).

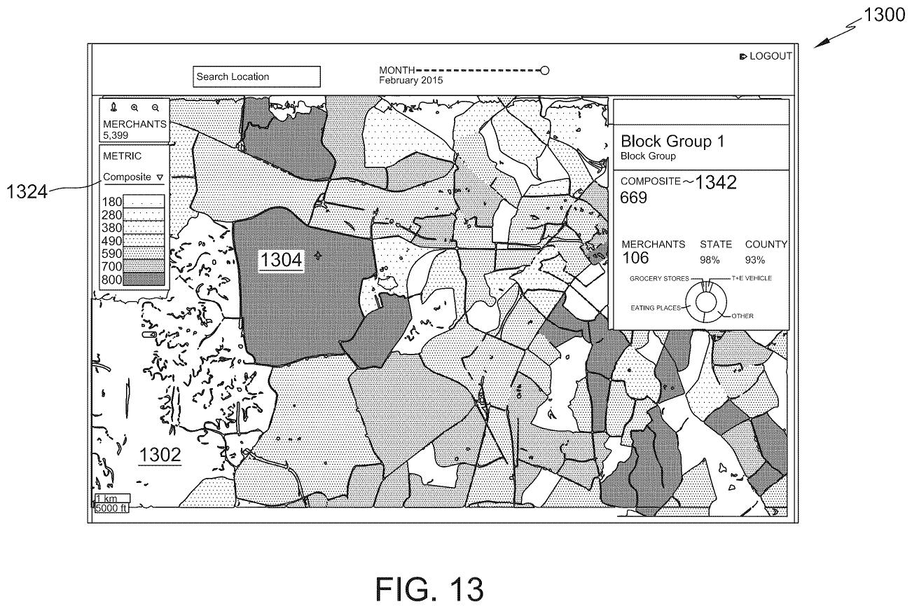

FIG. 13 depicts a screenshot 1300 showing a view 1302 that is the same in geographic scale as views 802, 902, 1002, 1102, and 1202 (shown in FIGS. 8, 9, 10, 11, and 12, respectively). View 1302 reflects the selected metric 1324, the merchant analytic of “Composite” (e.g., aggregated score). As described above, the composite score for a sector may be an average, weighted average, or some other aggregation of the other five scores for that sector. The selected sector 1304 Block Group 1 has a fairly high composite score 1342 of 669, which may be expected, considering three of the five previous scores were high for Block Group 1.

FIG. 14 depicts a screenshot 1400 showing a view 1402 that is same in geographical scale as views 802, 902, 1002, 1102, 1202, and 1302 (shown in FIGS. 8, 9, 10, 11, 12, and 13, respectively). Moreover, the selected metric 1424, as in view 1302, is “Composite.” However, it should be noted that the time-selection slider 1430 has been moved from February 2015 (as was selected in all previous views) to December 2012. The time-selection slider 1430 acts as a virtual “time machine,” allowing a user to see how the score for a sector has developed (i.e., increased or decreased) over time by dragging the slider 1430 from one point to another. In the example embodiment, the time-selection slider 1430 includes an interval indicator 1432, which denotes the number of months' worth of transaction data used to determine the scores shown in that particular view. The interval indicator 1432 in view 1402 reads “12,” indicating that 12-months' worth of data is included in the determined scores shown. In view 1402, one can see that the merchant number indicators of merchants 1418, 1448 have decreased, both in the view navigation module 1410 and in the smart chart 1440 for the selected sector 1404 (Block Group 1). This immediately informs the user that, from December 2012 to February 2015, the geographic area has experienced some manner of growth, as more merchant locations were present in February 2015 than December 2012, in the same geographic view. The composite score 1442 for Block Group 1 has also changed, indicating that the composite score 1342, 1442 for Block Group 1 decreased from December 2012 to February 2015. This may indicate that the selected sector 1404 is not performing as well relative to itself in December 2012, or may indicate that other sectors are performing better, relative to the selected sector 1404 (or some combination of the two scenarios). In some embodiments, some sectors may “disappear,” the further back in time the user goes on the user interface by moving slider 1430 “back in time,” as at that selected month (or other point in time), there was not twelve-months' worth (or any other minimum amount) of data yet for enough merchant locations to define or establish a sector at that geographic location.

FIG. 15 depicts a screenshot 1500 showing a view 1502 that is zoomed-in relative to views 802-1402 (shown in FIGS. 8-14). In view 1502, the user has toggled a “satellite” view by selecting “view type” icon 1512. Accordingly, the sectors are displayed overlaid upon satellite imagery of the geographic region. In some cases, such a view may help a user understand and visualize the boundaries of and between defined sectors. In addition, the defined sectors are at the block level. The selected sector 1504 is denoted as “Block 1001,” which was included in the “Block Group 1” (block-group level) sector shown in FIGS. 8-14. Accordingly, the number of merchants included in the selected sector 1504 is reduced (relative to the number of merchants in, for example, selected sector 1404 shown in FIG. 14), as shown in the merchant number indicator 1548, and the various analytics (e.g., Composite score 1542, in this example) are determined using data for the merchants in just that block sector.

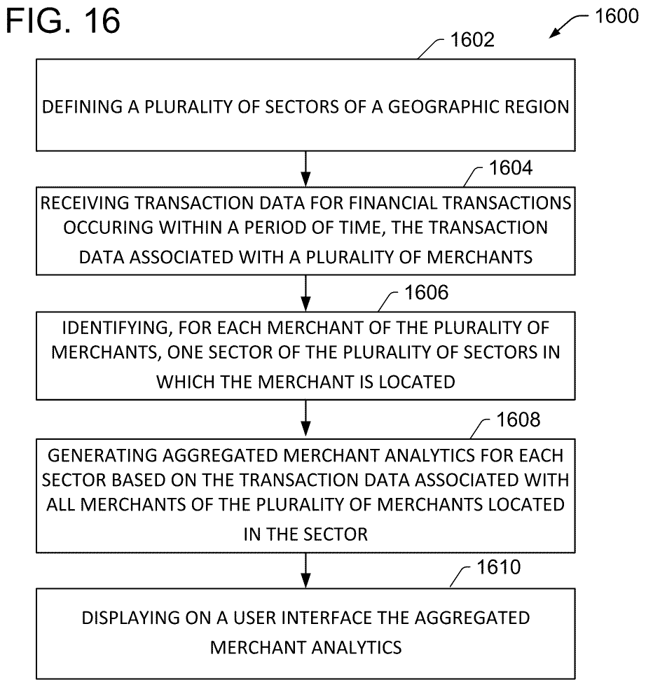

FIG. 16 is a simplified diagram of an example method 1600 for generating merchant analytics for a sector and providing the analytics on a user interface using merchant analytics computing device 112 (shown in FIG. 2). Specifically, merchant analytics computing device 112 defines 1602 a plurality of sectors of a geographic region. Additionally, merchant analytics computing device 112 receives 1604 transaction data (e.g., transaction data 540, shown in FIG. 5A) for a period of time. The transaction data may be associated with a plurality of merchants, and the plurality of merchants may be located in the geographic region. Additionally, merchant analytics computing device 112 identifies 1606, for each merchant of the plurality of merchants, one sector of the plurality of sectors in which the merchant is located. Additionally, merchant analytics computing device 112 generates 1608 aggregated merchant analytics (e.g., as output 590, also shown in FIG. 5A) for each sector based on the transaction data associated with all merchants of the plurality of merchants located in the sector. The aggregated merchant analytics may represent a ranking of each sector relative to all other sectors of the plurality of sectors. Additionally, merchant analytics computing device 112 displays 1610 on a user interface (e.g., user interface 118, shown in FIG. 2) the aggregated merchant analytics. The aggregated merchant analytics may be graphically represented on a map of the defined sectors. “Display,” as used in reference to merchant analytics computing device 112, may refer to any method in which merchant analytics computing device 112 facilitates or causes display of the merchant analytics on the user computing device.

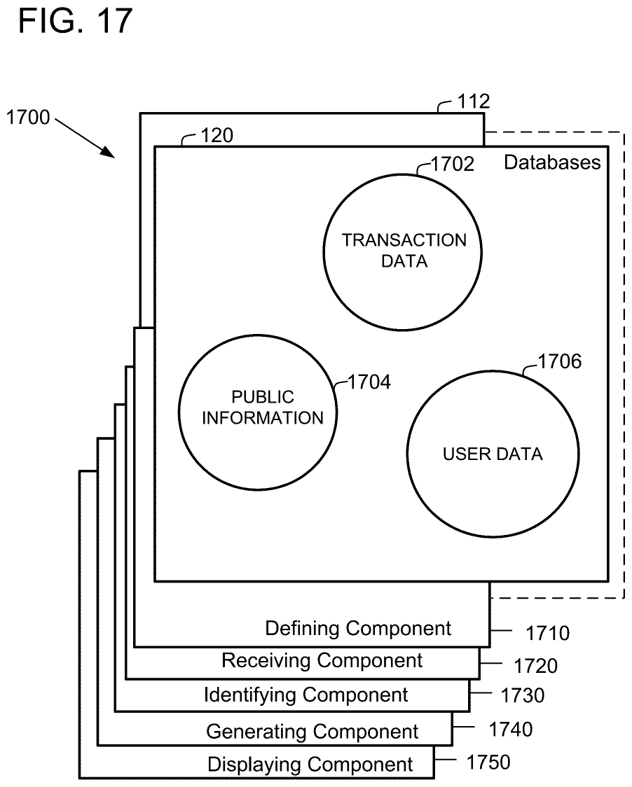

FIG. 17 is a diagram of components of one or more example computing devices that may be used in the environment shown in FIG. 2. FIG. 17 further shows a configuration of databases including at least database 120 (shown in FIG. 2). Database 120 may store information such as, for example, transaction data 1702, public information 1704, and user data 1706. Database 120 is coupled to several separate components within merchant analytics computing device 112, which perform specific tasks.

Merchant analytics computing device 112 includes a defining component 1710 for defining a plurality of sectors of a geographic region. Additionally, merchant analytics computing device 112 includes a receiving component 1720 for receiving transaction data for financial transactions occurring within a period of time. The transaction data is associated with a plurality of merchants, and the plurality of merchants are located in the geographic region. Additionally, merchant analytics computing device 112 includes an identifying component 1730 for, for each merchant of the plurality of merchants, one sector of the plurality of sectors in which the merchant is located. Additionally, merchant analytics computing device 112 includes a generating component 1740 for generating aggregated merchant analytics for each sector based on the transaction data associated with all merchants of the plurality of merchants located in the sector. The aggregated merchant analytics represent a ranking of each sector relative to all other sectors of the plurality of sectors. Additionally, merchant analytics computing device 112 includes a displaying component 1750 (alternatively referred to as a “display component”) for displaying on a user interface the aggregated merchant analytics. The aggregated merchant analytics are graphically represented on a map of the defined sectors.

In some implementations, generating component 1740 (or any other component of merchant analytics computing device 112) may be further configured to calculate a growth of each sector using received transaction data for a subset of the plurality of merchants located in each corresponding sector. The growth represents a difference in total sales revenue in each sector from a beginning of the period of time to an end of the period of time. Generating component 1740 may be further configured to determine a relative ranking for each sector by comparing the growth of each sector of the plurality of sectors and generate the growth score for each sector based on the relative ranking.

In some implementations, generating component 1740 (or any other component of merchant analytics computing device 112) may be further configured to calculate a stability of each sector using received transaction data for a subset of the plurality of merchants located in each corresponding sector. The stability represents maintenance of total sales revenue within a range of values around an average value of the total sales revenue in each sector during the period of time. Generating component 1740 may be further configured to determine a relative ranking for each sector by comparing the stability of each sector of the plurality of sectors, and generate the stability score for each sector based on the relative ranking.

In some implementations, generating component 1740 (or any other component of merchant analytics computing device 112) may be further configured to calculate a size of each sector using received transaction data for a subset of the plurality of merchants located in each corresponding sector. The size represents a total sales revenue in each sector during the period of time. Generating component 1740 may be further configured to determine a relative ranking for each sector by comparing the size of each sector of the plurality of sectors, and generate the size score for each sector based on the relative ranking.

In some implementations, generating component 1740 (or any other component of merchant analytics computing device 112) may be further configured to calculate a traffic of each sector using received transaction data for a subset of the plurality of merchants located in each corresponding sector. The traffic represents a number of transactions initiated in each sector during the period of time. Generating component 1740 may be further configured to determine a relative ranking for each sector by comparing the traffic of each sector of the plurality of sectors, and generate the traffic score for each sector based on the relative ranking.

In some implementations, generating component 1740 (or any other component of merchant analytics computing device 112) may be further configured to calculate an average ticket size for each sector using received transaction data for a subset of the plurality of merchants located in each corresponding sector. The average ticket size represents an average transaction amount in each sector during the period of time, and the average ticket size may be calculated by dividing a total sales revenue for a sector by a number of transactions initiated in the sector during the period of time. Generating component 1740 may be further configured to determine a relative ranking for each sector by comparing the average ticket size of each sector of the plurality of sectors, and generate the ticket size score for each sector based on the relative ranking.

In some implementations, generating component 1740 (or any other component of merchant analytics computing device 112) may be further configured to generate a growth score for each sector. The growth score represents a first relative ranking of the plurality of sectors based on a difference in total sales revenue in each sector from a beginning of the period of time to an end of the period of time. Generating component 1740 may also be configured to generate a stability score for each sector. The stability score represents a second relative ranking of the plurality of sectors based on a maintenance of a total sales revenue within a range of values around an average value of the total sales revenue in each sector during the period of time. Generating component 1740 may be further configured to generate a size score for each sector. The size score represents a third relative ranking of the plurality of sectors based on the total sales revenue in each sector during the period of time. Generating component 1740 may also be configured to generate a traffic score each sector. The traffic score represents a fourth relative ranking of the plurality of sectors based on a number of transactions initiated in each sector during the period of time. Generating component 1740 may further be configured to generate a ticket size score for each sector. The ticket size score represents a fifth relative ranking of the plurality of sectors based on an average transaction amount in each sector during the period of time. Generating component 1740 may still further be configured to generate the composite score for each sector. The composite score represents a sixth relative ranking of the plurality of sectors based on an aggregation of the growth score, the stability score, the size score, the traffic score, and the ticket size score of each sector.

In some implementations, generating component 1740 may be configured to generate a merchant record for each merchant of the plurality of merchants. Receiving component 1720 may be configured to receive an investment goal associated with the plurality of merchants. Identifying component 1730 may be configured to sort the plurality of merchant records according to the investment goal and the merchant analytics for each sector in which each merchant of the plurality of merchants is located. Causing or displaying component 1750 may be configured to present the sorted merchant records in an optimized merchant management portfolio.

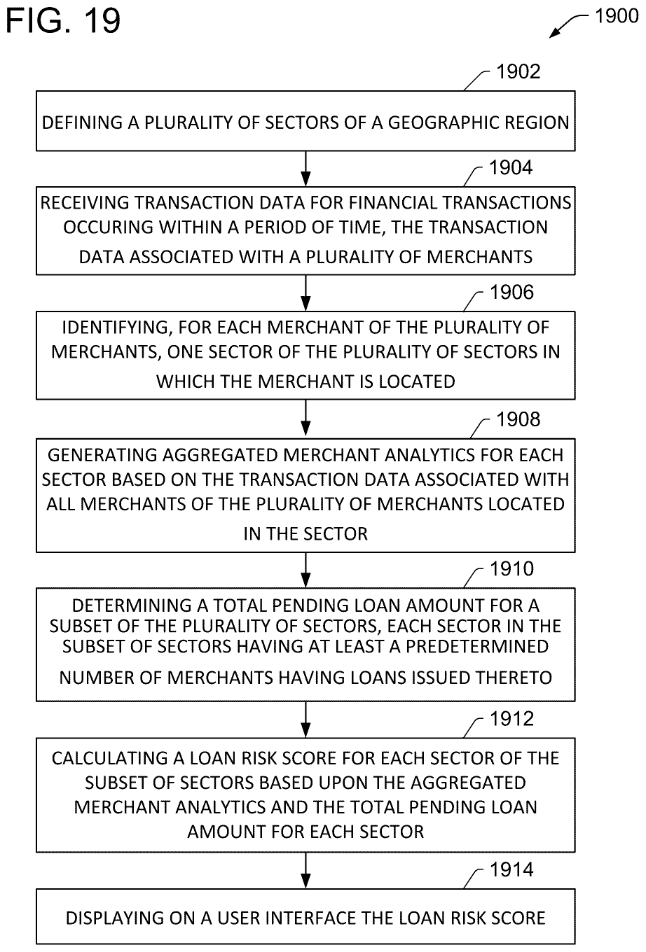

FIG. 19 is a simplified diagram of an example method 1900 for generating merchant analytics for a sector to determine a loan risk for the sector, and providing the analytics on a user interface using merchant analytics computing device 112 (shown in FIG. 2). Specifically, merchant analytics computing device 112 defines 1902 a plurality of sectors of a geographic region. Additionally, merchant analytics computing device 112 receives 1904 transaction data (e.g., transaction data 540, shown in FIG. 5A) for a period of time. The transaction data may be associated with a plurality of merchants, and the plurality of merchants may be located in the geographic region.

Additionally, merchant analytics computing device 112 identifies 1906, for each merchant of the plurality of merchants, one sector of the plurality of sectors in which the merchant is located. Additionally, merchant analytics computing device 112 generates 1908 aggregated merchant analytics (e.g., as output 590, also shown in FIG. 5A) for each sector based on the transaction data associated with all merchants of the plurality of merchants located in the sector. The aggregated merchant analytics may represent a ranking of each sector relative to all other sectors of the plurality of sectors.

Merchant analytics computing device 112 also determines 1910 a total pending loan amount for a subset of the plurality of sectors, each sector in the subset of sectors having at least a predetermined number of merchants having loans issued thereto. In some embodiments, the total pending loan amount is provided to merchant analytics computing device 112 by a user (e.g., a lender or a manager of a merchant loan portfolio). Merchant analytics computing device 112 calculates 1912 a loan risk score for each sector of the subset of sectors based upon the aggregated merchant analytics and the total pending loan amount for each sector. In addition, merchant analytics computing device 112 displays 1914 on a user interface (e.g., user interface 118, shown in FIG. 2) the aggregated merchant analytics. The aggregated merchant analytics may be graphically represented on a map of the defined sectors. “Display,” as used in reference to merchant analytics computing device 112, may refer to any method in which merchant analytics computing device 112 facilitates or causes display of the merchant analytics on the user computing device.

The computer-implemented methods discussed herein may include additional, fewer, or alternate actions, including those discussed elsewhere herein. The methods may be implemented via one or more local or remote processors, transceivers, servers, and/or sensors (such as processors, transceivers, and/or servers, and/or via computer-executable instructions stored on non-transitory computer-readable media or medium.

The embodiments described herein thus facilitate the real-time display of an interactive graphical UI configured such that a user may easily view aggregated merchant analytics for a sector and/or for a particular industry as, for example, a graphical representation displayed relative to a portfolio (e.g., as a table) and/or on a map. For example, the UI may include a graphical user interface with interactive functionality, such that aggregated merchant analytics may be shown in a graphical format. Moreover, at least by virtue of the ID-based organizational techniques, memory optimization techniques, and/or AI-based techniques described herein, the underlying analytics (e.g., metrics) data, sector data, and/or corresponding graphics data is able to be retrieved from memory and displayed for interaction with improved speed, fluidity, and efficiency, realizing reduced latency and/or other reductions in delay of the display of the analytics and/or the corresponding graphics. For example, by way of the manner in which the system disclosed herein learns which analytics and/or corresponding graphics the user most frequently views, data corresponding to the frequently viewed analytics and/or corresponding graphics can be stored in a memory in a manner that provides for faster data retrieval compared to other organizational schemes and/or other types of system memories. Put another way, the system disclosed herein utilizes a combination of techniques to better organize, store, and retrieve data, and to better learn usage trends such as which memory to use for a particular type of data based on usage patterns of a user. The data is stored may be hierarchical/prioritized manner in which the most frequently viewed data is stored in system memory that is most readily accessible (e.g., fastest retrieval) and data that is least frequently viewed is stored in other (e.g., slower retrieval) system memory.

In some embodiments, a server (e.g., server 116 and/or server system 301) is configured to implement machine learning, such that the server “learns” to analyze, organize, and/or process data without being explicitly programmed, such as in connection with AI/ML module 584 and model(s) 586. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, item classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based on the training data, the ML module may generate a predictive function which maps outputs to inputs and may utilize the predictive function to generate ML outputs based on data inputs. The example inputs and example outputs of the training data may include any of the data inputs or ML outputs described above. In the exemplary embodiment, a processing element may be trained by providing it with a large sample of merchants with known characteristics or features. Such information may include, for example, information associated with a plurality of merchants, geographic locations, merchant data, and/or images of various zoomed in or zoomed out geographical locations on a map and analytics data associated with those geographical locations.

In another embodiment, a ML module may employ unsupervised learning, which involves finding meaningful relationships in unorganized data. Unlike supervised learning, unsupervised learning does not involve user-initiated training based on example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based on feedback from a reward signal. Specifically, the ML module may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with voice bots or chatbots. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based on example inputs in order to make valid and reliable predictions for novel inputs.

Additionally, or alternatively, the machine learning programs may be trained by inputting sample data sets or certain data into the programs, such as metrics, shading/coloring, sector, and/or usage data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based on the discovered rule, accurately predict the correct output. In unsupervised machine learning, the processing element may be required to find its own structure in unlabeled example inputs.

In some embodiments, the system disclosed herein is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module (e.g., AI/ML module 584) is configured to implement ML methods and algorithms. In some embodiments, ML methods and algorithms are applied to data inputs and generate machine learning (ML) outputs. Data inputs may include, but are not limited to, analog and digital signals, image data, merchant data, video data, geographical location data at various zooned in or zoomed out levels for display on a map in combination with certain analytical data, and the like. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An analytics computing device comprising at least one processor in communication with at least one memory, the analytics computing device being in communication with a user computing device, the at least one processor programmed to:
cause a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located;
receive selection data corresponding to a plurality of selections made by the user via the GUI, wherein the selection data includes metrics request data associated with the plurality of merchant metrics and sector request data associated with the plurality of sectors;
analyze the selection data to determine (i) the requested merchant metrics of the plurality of merchant metrics that exceed a metrics request threshold and (ii) the requested sectors of the plurality of sectors that exceed a sector request threshold;
store a user profile in a first portion of the at least one memory including first data representing the requested merchant metrics satisfying the metrics request threshold and second data representing the requested sectors satisfying the sector request threshold; and
for a subsequent interaction with the GUI by the user, cause a graphical representation to be displayed via the GUI at the start of the subsequent interaction based on the user profile.

2. The analytics computing device of claim 1, wherein the at least one processor is further programmed to:
assign a unique identifier to at least one of: (i) each merchant metric of the plurality of merchant metrics, (ii) each merchant of the plurality of merchants, (iii) each sector of the plurality of sectors, or (iv) each merchant present in a designated sector of the plurality of sectors.

3. The analytics computing device of claim 2, wherein the at least one processor is further programmed to:
store the unique identifier in a data structure associated with the analytics computing device;
cause retrieval of the unique identifier in response to the subsequent interaction; and
load data corresponding to the retrieved unique identifier into the user profile.

4. The analytics computing device of claim 1, further comprising an artificial intelligence (AI) tool associated with the analytics computing device, wherein the AI tool includes at least one AI model, and wherein the at least one processor is further programmed to:
prior to the subsequent interaction, cause the at least one AI model to:
detect a change in a usage pattern of the user; and
output, based upon the detected change, an instruction to automatically store the metrics request data and/or the sector request data corresponding to the detected change in the first portion of the at least one memory.

5. The analytics computing device of claim 1, wherein the at least one processor is further programmed to:
cause other data that does not exceed either of the metrics request threshold or the sector request threshold to be stored in a second portion of the at least one memory different from the first portion.

6. The analytics computing device of claim 1, further comprising an additional memory and a table stored in the additional memory, and wherein the table is configured to store a plurality of unique identifiers associated with the selection data.

7. The analytics computing device of claim 6, further comprising an artificial intelligence (AI) tool associated with the analytics computing device, wherein the AI tool includes at least one AI model, and wherein the at least one processor is further programmed to:
prior to the subsequent interaction, cause the at least one AI model to:
detect a change in a usage pattern of the user;
output, based upon the detected change, an instruction to automatically generate a new table; and
store a set of unique identifiers of the plurality of unique identifiers corresponding to the detected change in the new table.

8. The analytics computing device of claim 6, wherein the graphical representation corresponding to the subsequent interaction includes a sector-based map, wherein the plurality of unique identifiers is configured to associate a portion of merchants of the plurality of merchants present within a designated sector of the plurality of sectors with the designated sector, and wherein the at least one processor is further programmed to:
determine, based upon a user input by the user, a user-requested sector; and
parse the plurality of unique identifiers to cause storage of data corresponding to the portion of merchants present within the user-requested sector in the first portion of the at least one memory.

9. The analytics computing device of claim 1, wherein (i) the plurality of sectors includes one or more of a country sector, a state sector, a city sector, a county sector, a neighborhood sector, a town sector, a block sector, and a street sector, and (ii) the plurality of merchant metrics includes one or more of growth metrics, stability metrics, size metrics, traffic metrics, and ticket size metrics.

10. A computer-implemented method using an analytics computing device comprising at least one processor in communication with at least one memory, the analytics computing device being in communication with a user computing device, the computer-implemented method comprising:
causing a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located;
receiving selection data corresponding to a plurality of selections made by the user via the GUI, wherein the selection data includes metrics request data associated with the plurality of merchant metrics and sector request data associated with the plurality of sectors;
analyzing the selection data to determine (i) the requested merchant metrics of the plurality of merchant metrics that exceed a metrics request threshold and (ii) the requested sectors of the plurality of sectors that exceed a sector request threshold;
storing a user profile in a first portion of the at least one memory including first data representing the requested merchant metrics satisfying the metrics request threshold and second data representing the requested sectors satisfying the sector request threshold; and
for a subsequent interaction with the GUI by the user, causing a graphical representation to be displayed via the GUI at the start of the subsequent interaction based on the user profile.

11. The computer-implemented method of claim 10, further comprising:
assigning a unique identifier to at least one of: (i) each merchant metric of the plurality of merchant metrics, (ii) each merchant of the plurality of merchants, (iii) each sector of the plurality of sectors, or (iv) each merchant present in a designated sector of the plurality of sectors.

12. The computer-implemented method of claim 10, wherein the at least one memory is at least one local cache memory, and wherein the first portion of the at least one memory is a portion of the at least one local cache memory that is most readily accessible for data retrieval and/or data storage compared to other portions of the at least one local cache memory.

13. The computer-implemented method of claim 10, wherein the analytics computing device includes an artificial intelligence (AI) tool associated with the analytics computing device, wherein the AI tool includes at least one AI model, and wherein the computer-implemented method further comprises:
prior to the subsequent interaction, causing the at least one AI model to:
detect a change in a usage pattern of the user; and
output, based upon the detected change, an instruction to automatically store the metrics request data and/or the sector request data corresponding to the detected change in the first portion of the at least one memory.

14. The computer-implemented method of claim 10, further comprising:
causing other data that does not exceed either of the metrics request threshold or the sector request threshold to be stored in a second portion of the at least one memory different from the first portion.

15. The computer-implemented method of claim 10, wherein the analytics computing device includes an additional memory and a table stored in the additional memory, and wherein the table is configured to store a plurality of unique identifiers associated with the selection data.

16. The computer-implemented method of claim 15, wherein the graphical representation corresponding to the subsequent interaction includes a sector-based map, wherein the plurality of unique identifiers is configured to associate a portion of merchants of the plurality of merchants present within a designated sector of the plurality of sectors with the designated sector, and wherein the computer-implemented method further comprises:
determining, based upon a user input by the user, a user-requested sector; and
parsing the plurality of unique identifiers to cause storage of data corresponding to the portion of merchants present within the user-requested sector in the first portion of the at least one memory.

17. At least one non-transitory computer-readable storage medium having computer-executable instructions embodied thereon, wherein when executed by at least one processor of an analytics computing device comprising the at least one processor in communication with at least one memory, the analytics computing device further being in communication with a user computing device, the computer-executable instructions cause the at least one processor to:
cause a graphical user interface (GUI) to be presented on a display of the user computing device for interaction by a user associated with the user computing device, wherein the GUI includes a graphical representation for each of (i) a plurality of merchant metrics associated with a plurality of merchants and (ii) a plurality of sectors of a geographic region in which each of the plurality of merchants is located;
receive selection data corresponding to a plurality of selections made by the user via the GUI, wherein the selection data includes metrics request data associated with the plurality of merchant metrics and sector request data associated with the plurality of sectors;
analyze the selection data to determine (i) the requested merchant metrics of the plurality of merchant metrics that exceed a metrics request threshold and (ii) the requested sectors of the plurality of sectors that exceed a sector request threshold;
store a user profile in a first portion of the at least one memory including first data representing the requested merchant metrics satisfying the metrics request threshold and second data representing the requested sectors satisfying the sector request threshold; and
for a subsequent interaction with the GUI by the user, cause a graphical representation to be displayed via the GUI at the start of the subsequent interaction based on the user profile.

18. The at least one non-transitory computer-readable storage medium of claim 17, wherein the computer-executable instructions further cause the at least one processor to:
assign a unique identifier to at least one of: (i) each merchant metric of the plurality of merchant metrics, (ii) each merchant of the plurality of merchants, (iii) each sector of the plurality of sectors, or (iv) each merchant present in a designated sector of the plurality of sectors.

19. The at least one non-transitory computer-readable storage medium of claim 17, wherein the analytics computing device includes (i) an additional memory and a table stored in the additional memory, wherein the table is configured to store a plurality of unique identifiers associated with the selection data and (ii) an artificial intelligence (AI) tool associated with the analytics computing device, wherein the AI tool includes at least one AI model, and wherein the computer-executable instructions further cause the at least one processor to:
prior to the subsequent interaction, cause the at least one AI model to:
detect a change in a usage pattern of the user;
output, based upon the detected change, an instruction to automatically generate a new table; and
store a set of unique identifiers of the plurality of unique identifiers corresponding to the detected change in the new table.

20. The at least one non-transitory computer-readable storage medium of claim 17, wherein the analytics computing device includes an additional memory and a table stored in the additional memory, wherein the table is configured to store a plurality of unique identifiers associated with the selection data, wherein the graphical representation corresponding to the subsequent interaction includes a sector-based map, wherein the plurality of unique identifiers is configured to associate a portion of merchants of the plurality of merchants present within a designated sector of the plurality of sectors with the designated sector, and wherein the computer-executable instructions further cause the at least one processor to:
determine, based upon a user input by the user, a user-requested sector; and
parse the plurality of unique identifiers to cause storage of data corresponding to the portion of merchants present within the user-requested sector in the first portion of the at least one memory.
